(19) United States
(12) Patent Application Publication
(10) Pub. No.: US 2020/0258020 A1
(43) Pub. Date: Aug. 13, 2020

(54) A METHOD FOR RESOURCE ALLOCATION IN A UTILITY SERVICE NETWORK

(71) Applicant: CHADDENWYCH SERVICES LIMITED, London, Greater London (GB)

(72) Inventors: William Paul ELLIS, Surrey (GB); Alun Geoffrey PERKINS, London, Greater London (GB); Wojciech IDEC, Munchen (DE); Jeremy Nicholas Paul ELLIS, Surrey (GB)

(21) Appl. No.: 16/479,849

(22) PCT Filed: Jan. 18, 2018
(86) PCT No.: PCT/GB2018/050149

§ 371 Date: Jul. 22, 2019

(30) Foreign Application Priority Data
Jan. 23, 2017 (GB) 1701125.5

(51) Int. Cl. G06Q 10/06; G06F 16/23; G06F 9/50; G06Q 40/04; G06Q 30/00; G06Q 50/06; G06Q 20/12; H02J 3/38

(52) U.S. Cl. CPC G06Q 10/06315; G06F 16/2379; G06F 9/5083; G06Q 40/04; H02J 2300/22; G06Q 50/06; G06Q 20/127; H02J 3/381; G06Q 30/0185

(57) ABSTRACT

The invention relates to methods, apparatus, computer programs and computer-readable media, for resource allocation in a utility network comprising a number of resource components including one or more utility sources, a number of infrastructure elements and one or more consumer elements. A method and system for allocating utility resources in such a utility network comprises causing registration data to be stored in response to an indication that a first component wishes to participate in provision of a utility product from one or more utility sources to a consumer element. The method and system further refer to a number of solution engines which, responsive to the registration data, determine one or more solutions involving components for providing the utility product, and cause solution data to be stored. The method and system further refer to an umpire module that, responsive to the solution data, selects a solution and causes resource components to be allocated based on the selected solution, by causing a Blockchain data store to be modified according to the selected solution.

### FIELD OF THE INVENTION

The invention relates to methods, apparatus, computer programs and computer-readable media for resource allocation in a utility service network.

### BACKGROUND

Existing methods and systems have been employed to allocate resources (such as generation/sourcing and transmission/pipeline infrastructure capacity) in a utility network (such as a gas, electricity, broadband network etc.) for providing utility services to consumers. A problem with existing methods and systems is that it can be difficult to accurately and effectively identify capacity and infrastructure elements which can collaborate to provide a particular utility service consumption demand, and match/allocate those elements to the demand. Further, in order for longer-term reliability of supply and delivery it is necessary that capacity and infrastructure is maintained, and to this end, providers of such capacity and infrastructure must be sustainably compensated otherwise capacity and infrastructure can degrade. It has hitherto been difficult to efficiently and accurately achieve these aims.

Existing electronic platforms have been used to allocate resources within a utility network for providing utility services, however those existing platforms have failed to operate entirely satisfactorily.

A Blockchain is a type of decentralised database, employing public key cryptography to maintain a growing list (or “chain”) of ordered records (“blocks”), which is resistant to tampering by virtue of each newly added block depending on a result of a cryptographic operation performed on the previous block. The list of blocks, i.e. the Blockchain, may be publicly accessible or accessible to groups of authorised users, and yet by virtue of the use of chained cryptographic operations is tamper-resistant, since multiple parties are able to inspect, verify, and perform operations upon the Blockchain to verify data comprised therein. Consensus is reached regarding the state of the Blockchain without any need for trust between entities modifying it, by using a method such as “proof of work” or “proof of stake”.

Blockchain principles have been used for electronic currency, “Bitcoin” being one example, due to a Blockchain's ability to ensure that the same Bitcoin cannot be spent twice. This guarantee comes due to the properties of the Blockchain database. The “Ethereum” system also uses Blockchain principles, and adds a Turing-complete scripting language capability, such that the Blockchain can be used to store not only data, but also application programs and their state, wherein the programs can perform operations on the data, taking into account the program state. Such a Blockchain system can be considered to be a virtual machine holding data and programs that operate on the data.

### SUMMARY

The methods and systems presented herein address the above-mentioned problems, by virtue of more accurately, flexibly and efficiently allocating generation/sourcing capacity and infrastructure resource capacity in a utility network to provide utility service(s) to consumers. The methods and systems presented furthermore help to ensure that the costs of providing such capacity are more accurately met, in an efficient manner, thereby helping to ensure sustainable and reliable provision of such utility services.

Aspects of the invention are defined in the appended claims.

In a first aspect there is provided a method for resource allocation in a utility service network that comprises, as components, one or more sources, a number of infrastructure elements and one or more consumer elements, the method comprising:
responsive to an indication that a first component wishes to participate in provision of a utility product from a source to a consumer element, causing first data relating to the indication and associated with the first component to be stored in a first data store;
responsive to determining that the first data store stores such first data,
   determining one or more solutions for the provision, each solution comprising information relating to a plurality of components including the first component which can participate to facilitate the provision,
   selecting one of said solutions according to a first criterion, and
   causing a second data entry relating to the selected solution to be stored in a second data store; and
responsive to determining that the second data store stores such second data entries,
   selecting one of the entries of second data according to a second criterion, and
   causing a blockchain data store to be modified according to the selected entry of second data.

In a second aspect there is provided a method for resource allocation in a utility service network that comprises, as components, one or more sources, a number of infrastructure elements and one or more consumer elements, the method comprising:
responsive to an indication that a first component wishes to participate in provision of a utility product from a source to a consumer element, causing first data relating to the indication and associated with the first component to be stored in a first data store, wherein the first data comprises one or more conditions required by the first component for its participation in the provision;
responsive to detecting second data relating to a solution for the provision, the solution comprising information relating to a plurality of components including the first component which can participate to facilitate the provision, verifying that the one or more conditions are met by the solution; and
responsive to a positive verification, providing an indication that resources of the component are permitted to be allocated according to the second data.

In a third aspect there is provided a method for resource allocation in a utility service network that comprises, as components, one or more sources, a number of infrastructure elements and one or more consumer elements, the method comprising:
responsive to determining that a first data store stores first data associated with a first component and relating to an indication that the first component wishes to participate in provision of a utility product from a source to a consumer element:
   determining one or more solutions for the provision, each solution comprising information relating to a plurality of components including the first component which can participate to facilitate the provision,
   selecting one of said solutions according to a first criterion, and
   causing a second data entry relating to the selected solution to be stored in a second data store.

In a fourth aspect there is provided a method for resource allocation in a utility service network that comprises, as components, one or more sources, a number of infrastructure elements and one or more consumer elements, the method comprising:
responsive to determining that a second data store stores second data entries, each entry relating to a respective solution comprising information relating to a plurality of components which can participate to facilitate provision of a utility product from a source to a consumer element,
   selecting one of the entries of second data according to a second criterion, and
   causing a blockchain data store to be modified according to the selected entry of second data.

Optionally, the method further comprises: making accessible the selected entry of second data for verification of whether the selected entry of second data meets one or more conditions required by the components associated with the selected entry, and wherein the step of causing a blockchain data store to be modified is conditional upon receiving an indication that such conditions are met by the selected entry.

Optionally the method further comprises auditing the blockchain data store to ensure that a record of a selected entry of second data is valid according to a verification criteria.

Optionally the method further comprises causing to be stored, in the second data store, one or more further entries of second data each relating to a further selected solution for the provision, prior to the determining that the second data store stores such second data entries.

Optionally the first data store and/or the second data store are also implemented using blockchain techniques.

Optionally the blockchain data store is separate from the first data store, and/or the blockchain data store is separate from the second data store.

Optionally the first data comprises one or more of: information identifying the first component; information identifying a time period during which the first component wishes to participate in the provision; information relating to a cost or benefit to the first component for participation in the provision; and information identifying a location of the first component.

Optionally the first data comprises one or more conditions required by the first component for its participation in the provision, and optionally the first data store is implemented using blockchain techniques and the first data comprises executable code arranged to perform verification that a second data entry meets the conditions. Optionally the one or more conditions comprise a predetermined time period and a predetermined provision cost at which the first component wishes to participate in the provision of the utility product. Optionally the one or more conditions comprise a predetermined benefit which the first component agrees to receive for participating in the provision of the utility product in return for agreeing to not be provided with such a utility product for a predefined time period. Optionally the first data store is implemented using blockchain techniques and the first data comprises executable code arranged to modify the conditions required by the first component in response to detecting a change of conditions required by another component. Optionally, in response to a change in a cost associated with participation by the other component in the provision, the executable code modifies the conditions of the first component, and optionally so as to change the time period that the first component wishes to participate in the provision.

Optionally the determining one or more solutions comprises, for each source of the plurality of components, identifying infrastructure elements associated with the respective source that can participate in the provision of the utility product to a consumer element that is associated with the respective source. Optionally the determining comprises traversing one or more paths from the respective source to the respective consumer element, and a respective solution comprises information identifying components along the respective path. Optionally each solution comprises, for each identified source and infrastructure element, one or more of: an identification, a minimum cost per unit, a minimum volume amount, and an indication of a time period. Optionally each solution comprises, for each identified consumer element, one or more of: an identification, a maximum cost per unit, a maximum volume amount, and an indication of a time period. Optionally the first data comprises data and/or executable code for facilitating the determination of the solutions.

Optionally the first criterion comprises one or more of: a lowest solution cost, a highest remaining spare capacity for components used in the solution, and a most evenly balanced capacity usage between components used in the solution.

Optionally the second data comprises one or more of: information identifying components which it is proposed will participate in the provision, the identified components comprising at least one source, a number of infrastructure elements, and at least one consumer element; information identifying a time period that the utility product is to be provided for; and for each of the identified components, information relating to one or more of a cost or benefit for the respective entity to participate, a rate and/or volume of utility, and a weighting factor indicating a contribution made to the provision by the respective component.

Optionally, infrastructure elements comprise one or more of transmission lines, pipes, power transformers, switches, cables, antennas, balancing, storage and distribution service elements.

Optionally, a component comprises one of: a utility source from which a utility product can be sourced; an infrastructure element which can facilitate the provision of a utility product; a consumer element to which the utility product can be provided; a consumer element which agrees to not be provided with the utility product for a predetermined period; and a consumer element to which the utility product is provided and which agrees to change consumption of the utility product in response to a signal.

Optionally, one or both of: the step of selecting one of the entries of second data; and the step of causing a blockchain data store to be modified; are carried out under control of program code comprised in the blockchain data store and executed by a processor associated with the blockchain data store. Optionally, the program code further comprises instructions arranged to apportion any excess of: cost or capacity associated with participation in the provision by the consumer element, minus the total of costs or capacity associated with participation by all of the sources and infrastructure elements associated with the selected entry of second data; wherein the excess is apportioned between the components according to a contribution made to the provision by each component; and optionally wherein the excess is apportioned according to a Shapley Value calculation.

Optionally the second criterion comprises one or more of: whichever second data entry will satisfy the participation wishes of the greatest number of first components; whichever second data entry will result in the allocation of the greatest volume of source and/or infrastructure resource; whichever second data entry will result in the lowest cost per unit of resource supplied; and whichever second data will result in the greatest level of spare capacity in the components associated with the respective second data entry.

Optionally, the utility service network is a first sub-network comprised within a larger utility service network that comprises at least a second sub-network. Optionally, the components of the first sub-network comprise a virtual consumer element, and components of the second sub-network comprise a virtual source, and wherein utility supplied into the second sub-network by the virtual source corresponds with utility consumed from the first sub-network by the virtual consumer. Optionally, each of the first and second sub-networks is similarly sub-divided.

In a fifth aspect there is provided an apparatus arranged to carry out a method according to any one of the preceding aspects.

In a sixth aspect there is provided a system for resource allocation in a utility service network which network comprises, as components, one or more sources, a number of infrastructure elements and one or more consumer elements, the system comprising:
means for, responsive to an indication that a first component wishes to participate in provision of a utility product from a source to a consumer element, causing first data relating to the indication an associated with the first component to be stored in a first data store;
means for determining that the first data store stores such first data, and in response thereto,
   determining one or more solutions for the provision, each solution comprising information relating to a plurality of components including the first component which can participate to facilitate the provision,
   selecting one of said solutions according to a first criterion, and
   causing a second data entry relating to the selected solution to be stored in a second data store; and
means for determining that the second data store stores such second data entries, and in response thereto,
   selecting one of the entries of second data according to a second criterion, and
   causing a blockchain data store to be modified according to the selected entry of second data.

In a seventh aspect there is provided a system for resource allocation in a utility service network which network comprises, as components, one or more sources, a number of infrastructure elements and one or more consumer elements, the system comprising:
a first module arranged to, responsive to an indication that a first component wishes to participate in provision of a utility product from a source to a consumer element, cause first data relating to the indication and associated with the first component to be stored in a first data store;
one or more solution engines each arranged to determine that the first data store stores such first data, and in response thereto
   determine one or more solutions for the provision, each solution comprising information relating to a plurality of components including the first component which can participate to facilitate the provision,
   select one of said solutions according to a first criterion, and
   cause a second data entry relating to the selected solution to be stored in a second data store; and
an umpire module arranged to determine that the second data store comprises one or more entries of such second data, and in response thereto
   select one of the entries of second data according to a second criterion, and
   cause a blockchain data store to be modified according to the selected entry of second data.

In an eighth aspect there is provided a module for resource allocation in a utility service network which network comprises, as components, one or more sources, a number of infrastructure elements and one or more consumer elements, the module arranged to:
detect an indication that a first component wishes to participate in provision of a utility product from a source to a consumer element, and in response thereto, cause first data relating to the indication and associated with the first component to be stored in a first data store, wherein the first data comprises one or more conditions required by the first component for its participation in the provision;
detect second data relating to a solution for the provision, the solution comprising information relating to a plurality of components including the first component which can participate to facilitate the provision, and in response thereto, verify that the one or more conditions are met by the solution; and
responsive to a positive verification, provide an indication that resources of the component are permitted to be allocated according to the second data.

In a ninth aspect there is provided a solution engine for resource allocation in a utility service network which network comprises, as components, one or more sources, a number of infrastructure elements and one or more consumer elements, the solution engine arranged to:
determine that a first data store stores first data associated with a first component and relating to an indication that the first component wishes to participate in provision of a utility product from a source to a consumer element, and in response thereto:
   determine one or more solutions for the provision, each solution comprising information relating to a plurality of components including the first component which can participate to facilitate the provision,
   select one of said solutions according to a first criterion, and
   cause a second data entry relating to the selected solution to be stored in a second data store.

In a tenth aspect there is provided an umpire module for resource allocation in a utility service network which network comprises, as components, one or more sources, a number of infrastructure elements and one or more consumer elements, the module arranged to:
determine that a second data store stores second data entries, each entry relating to a respective solution comprising information relating to a plurality of components which can participate to facilitate provision of a utility product from a source to a consumer element, and in response thereto,
   select one of the entries of second data according to a second criterion, and
   cause a blockchain data store to be modified according to the selected entry of second data.

In an eleventh aspect there is provided a computer program comprising instructions which, when executed by one or more processors, cause the one or more processors to perform a method according to any of the first to fourth aspects.

In a twelfth aspect there is provided a computer-readable medium storing instructions which, when executed by one or more processors, cause the one or more processors to carry out a method according to any of the first to fourth aspects.

It will be appreciated in the light of the present disclosure that certain features of certain aspects and/or embodiments described herein can be advantageously combined with those of other aspects and/or embodiments. The following description of specific embodiments should not therefore be interpreted as indicating that all of the described steps and/or features are essential. Instead, it will be understood that certain steps and/or features are optional by virtue of their function or purpose, even where those steps or features are not explicitly described as being optional. The above aspects are thus not intended to limit the invention, and instead the invention is defined by the appended claims.

### BRIEF DESCRIPTION OF THE FIGURES

In order that the invention may be understood, preferred embodiments are described below, by way of example, with reference to the Figures in which like features are provided with like reference numerals. Figures are not necessarily drawn to scale.

FIG. 1 is a representation of a utility network comprising, as components, sources (e.g. generators), Infrastructure elements (e.g. transmission and distribution components), and consumer elements (e.g. factories, houses, blocks of flats etc.).

FIG. 2 shows highlighted components of such a utility network which can cooperate to provide a utility product from a source to a consumer element.

FIG. 3 is similar to FIG. 2, but shows a finer-grained sub-division of distribution components involved in the provision of a utility product.

FIG. 4 is a representation of a “recipe”, known by each source component (in this case the “Gen. 2” component), for delivering its utility product.

FIG. 5 is a representation of a grid-type of utility network.

FIG. 6 is a representation of the grid network of FIG. 5, with components highlighted that are involved in the provision of a utility product.

FIG. 7 is a representation of a grid-type of utility network that has been subdivided by two, such that each sub-network comprises fewer components, and showing that one sub-grid can supply a virtual product, which appears as a corresponding virtual source in the other sub-grid.

FIG. 8 is a representation of the grid network of FIG. 7, with components highlighted that are involved in the supply of a utility product from solar panels 810 to virtual product 780, and with components highlighted that are involved in the supply of a utility product from virtual source 770 to block of flats 860.

FIG. 9 is a block diagram of a system for allocating resources in a utility network according to embodiments.

FIGS. 10a and 10b are block diagrams illustrating an example embodiment of the system of FIG. 9.

FIG. 11 is a process flow diagram showing steps of a method according to embodiments, performed either as part of a complete system for allocating resources, and/or performed by a registration module comprised in such a system.

FIG. 12 is a process flow diagram showing steps of a method according to embodiments, performed either as part of a complete system for allocating resources, and/or performed by a solution engine comprised in such a system.

FIG. 13 is a process flow diagram showing steps of a method according to embodiments, performed either as part of a complete system for allocating resources, and/or performed by an umpire module comprised in such a system.

FIG. 14 is a bar chart showing an example of Shapley values calculated for sustainable sharing of excess capacity and/or excess cost compensation.

FIG. 15 is a line graph showing how a calculated Shapley value varies for various cost values.

FIG. 16 is a diagram showing an example architecture for a computer system which could be used to implement embodiments.

FIG. 17 is a block diagram showing elements of an example computing device which could be employed in the system of FIG. 16.

### DETAILED DESCRIPTION

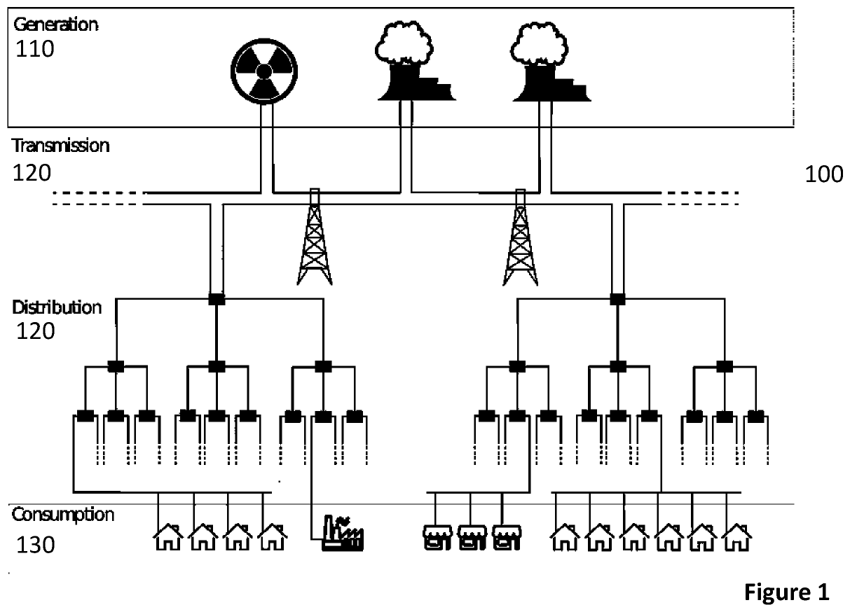

A utility network 100 as shown in FIG. 1 comprises, as “components”, the following elements which collaborate to provide a utility product (such as electricity, gas, telephone, broadband etc.) over the network. The components include:
a source 110 (such as a coal or nuclear power station, wind turbine, solar power generation facility, gas distribution centre, communications data centre, water distribution centre, etc.) from which the product is provided;
a consumer element 130 (such as a house or factory) to which the product is provided; and
optionally one or more infrastructure elements 120 (such as electricity transmission lines, distribution lines, transformers, gas pipelines, telephone lines, microwave links, balancing controller, storage elements, etc.) by which the product is provided.

A Demand Side Response (DSR) controller is a further type of component that can be considered to be a type of source component, since it causes a DSR product to exist at a consumer, optionally also affecting a number of infrastructure elements.

Another way of making product available is by controlling and allocating output of localised micro-generators, which can supply product to a local consumer element within a local utility network. Conceptually, a micro-generator can be considered to be a small type of source, but alternatively can in some instances be considered to be a DSR-capable consumer element, since it may be local to a consumer element and may supply some or all of that consumer element's consumption needs, thereby reducing the amount of product that must be provided to that consumer element across the wider network. Such a DSR-capable consumer element could schedule, with a DSR controller, times when it would run its micro-generator, or could respond to a signal by running or stopping its microgenerator, thereby reducing or increasing consumption from the network.

Generally, the total product being consumed by all consumer elements must be equal to the total product being generated by all sources. For the sake of clarity, the rest of this disclosure will consider only an electricity utility network, however it will be understood by the skilled reader that the present disclosure can be applied to any other type of utility service and/or network, including but not limited to gas, oil, or other fuels, telecommunications, and water networks, by way of examples.

A characteristic of such utility networks is that different types of components (sources, infrastructure elements and consumer elements) may cooperate to deliver a utility product from a source to a consumer element. Each type of component has a particular job to do in order that the product can be provided, and different types of component can be competing or non-competing between each other. This can present problems for efficient and sustainable provision of utility products, as described later.

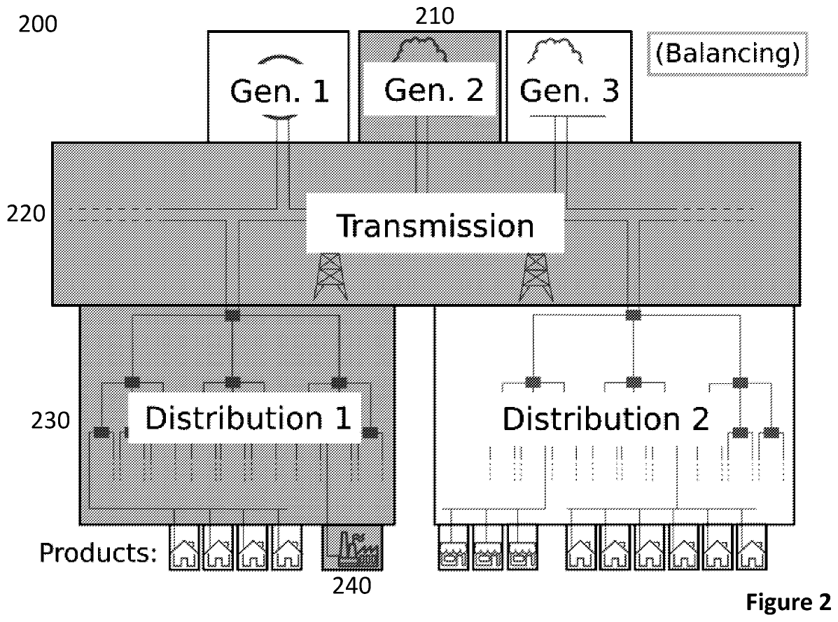

FIG. 2 shows a utility network such as that of FIG. 1, wherein some of the components comprised therein have been “allocated” for a task of providing a utility product from a source 210 to a consumer element 240 via transmission element 220 and distribution element 230. Transmission element 220 and distribution element 230 are both types of infrastructure elements 120. It can be seen that although the three generation components (which are sources) could compete between each other to be the source 210 of the product (since each can substitute for the role of another), both the transmission component 220 and the distribution component 230 are required in order for the utility to be delivered to the consumer element (e.g. a house) 240, therefore neither the transmission component 220 or the distribution component 230 can be substituted for the role of the other, and so they do not compete with each other—in other words they can be said to be “non-rival”.

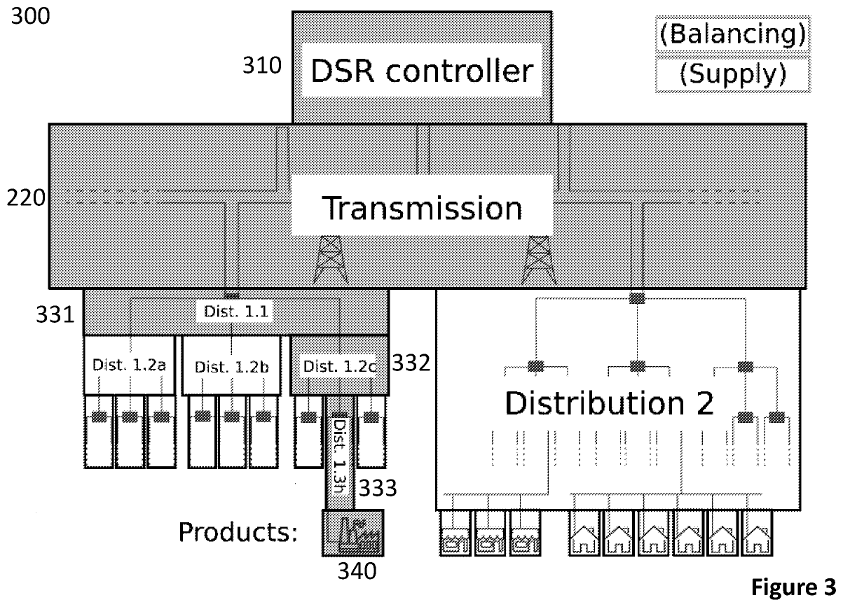

FIG. 3 illustrates that a utility network 300 can be more finely divided than the utility network 200 shown in FIG. 2. In FIG. 3, a distribution component equivalent to the distribution component 230 shown in FIG. 2 has been sub-divided into three sub-distribution components 331, 332, 333, which are all participants in the provision of a utility product to consumer element 340. Greater or lesser subdivision can exist in utility networks, and such networks are not necessarily constructed as tree structures therefore there may be greater than one source supplying greater than one consumer element, and/or there may be multiple paths between each source and consumer element, each path optionally comprising one or more infrastructure elements. All of the components in a particular path from source to consumer element participate (or “collaborate”) in supplying the utility product from the respective source to the respective consumer element(s).

In certain embodiments, as shown in FIG. 3, a source element can comprise a DSR (Demand Side Response) controller 310, for coordinating changes in DSR-capable consumer elements' demand, to adjust demand through the network. Each source 310 and each optional infrastructure element 220, 331, 332, 333 has a maximum capacity and/or throughput (e.g. a maximum generation power output or a maximum current carrying capability/maximum voltage). A particularly advantageous aspect of Demand Side Response control is that peak capacity experienced at any component in the network can be reduced by means of arranging for a heavily consuming consumer element, such as a factory 340, to reduce its consumption at times when other consumer elements are known (either in advance or by monitoring, e.g. using smart meters) to consume relatively large amounts of product compared to other times. A DSR controller 310 can command such consumer elements 340 with DSR capability to change their consumption by: instantaneously sending them a signal which is active during which time the consumption decrement is to occur; and/or by communicating and agreeing, in advance, a time period during which consumption will be reduced. By reducing consumption of a particular consumer element 340 at peak consumption periods, peak levels of utility required from sources and optionally carried via infrastructure elements 220, 331, 332 (which in this example are arranged to deliver utility product to other consumer elements and are shared with the DSR consumer element 340), can be reduced. This not only makes more efficient use of existing components, but also increases reliability and longevity since situations can be avoided where components are operated near, at or over their maximum capacity rating (e.g. maximum current, voltage and/or power). By operating components well within their normal operating capacity, stress on the components is reduced, and as a result maintenance and repair costs are reduced, while reliability is increased and maintenance/operating costs are decreased. By way of example, in embodiments, such an instantaneous DSR signal as mentioned above (provided by a DSR controller 310) can be an electrical voltage or current, and/or data transmitted across a computer network, and such data can represent: a binary on/off state, a throttling value, and/or a value reflecting the maintenance/operating cost and/or stress level of the components participating in the supply of the utility product. A DSR consumer element 340 can respond appropriately by one or more of: ceasing consumption, reducing consumption according to such a throttling value, and/or by reducing or re-scheduling consumption according to such a cost indicator and/or stress level indicator. This facility is anticipated to be particularly advantageous in situations where large numbers of electric vehicles are being charged, e.g. overnight. A DSR controller 310 can be arranged to automatically control the re-scheduling of product consumption, such that electric vehicle chargers are scheduled to consume product at different times, thereby spreading their load over a longer time period and avoiding peaks in consumption which might otherwise occur.

### Products and Solutions

In embodiments, a product has an associated start time, duration, location and product type ID. The location of the consumer element 340 (that consumes the product) affects which other components are involved in delivering the product to the consumer element 340. A product is a combination of at least one source with zero or more infrastructure elements, and there may be more than one way of composing a product from such components—e.g. there may be a choice of source and/or a choice of infrastructure elements that can be assembled together to create the product. The utility network can be denoted as a graph G, the locations of all possible products can be denoted as the set of locations L, and the set of all possible products can be denoted P.

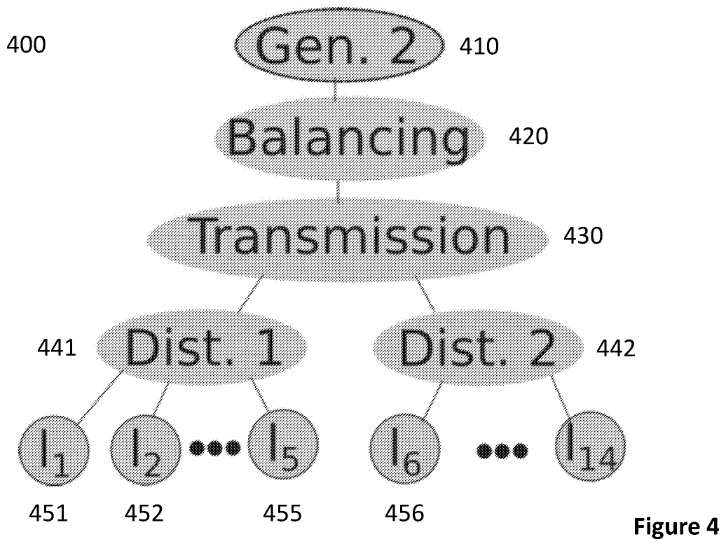

As shown in FIG. 4, each source component 210, 410 knows the type of utility product that it sources, and knows which (if any) infrastructure elements 420, 430, 441, 442 are required to deliver that product. As such, each source component 210, 410 knows a “recipe” 400 comprising the required components for providing its product to any of one or more consumer elements 451-456 that are connected to it, at their respective locations. From a source's recipe 400 it is possible to construct one or more “solutions” for delivering a utility product from that source 410 to one of its connected consumer elements 451-456. Each solution comprises a plurality of components including the source 410 and zero or more interconnected infrastructure elements, and represents at least one path from the source 410 to whichever consumer element 451-456 may wish to be provided with a utility product. An example of how recipes and solutions can be represented in the form of data structures will be detailed below. Of course, it will be understood that any suitable data structure can be used and the following example is non-limiting, the invention being defined by the appended claims.

By way of example, a product p has at least:
a product type ID i
an allocation time unit δt
a location l

wherein the product type ID i and the location l are sufficient to uniquely identify the product p, which can be denoted thus:

p=(i,δt,l)

The allocation time unit δt defines whether the product can, for example, be allocated in half-hour blocks, or five-minute blocks etc. In embodiments, the system can have a smallest divisible time unit (e.g. 5 minutes), and a maximum time unit allocation, wherein all time allocations are integer multiples of the smallest divisible time unit, and are within the maximum time unit allocation. In embodiments, the time units allocated can be constrained to start and/or end at predefined time boundaries.

To create a product p, a source and optionally a number of infrastructure elements are brought together as a potential solution. Depending on the network structure, there may be more than one way to create the product, and any particular component may be involved in the creation/provision of more than one product.

The set of all possible infrastructure elements can be denoted C. An infrastructure element c has at least:
an infrastructure element type ID k
an allocation time unit δt
a location l (e.g. the vertex of the infrastructure element in the network graph G)

c=(k,δt,l)

wherein the infrastructure element type ID k can be used to reference a record of all other infrastructure element properties that are relevant for determining a solution for providing a particular product. The infrastructure element type ID k and its location l are together sufficient to uniquely identify the infrastructure element.

The set of all possible sources can be denoted S. A source s is associated with a recipe, which prescribes how to connect the source to one or more consumer elements for the delivery/provision of a product, optionally via one or more infrastructure elements, and each source can be denoted as having at least:
a source type ID j
an allocation time unit δt
a product type ID i of the product type it provides, or a set thereof l
a set L of locations l that the source can provide product to
a recipe π (or recipe πᵢ for each product type i the source can provide)

s=(j,δt,i, [symbol] ,π)

The controller/owner of the source component is usually responsible for providing the recipe(s), although the recipe can be provided from elsewhere. A recipe ii for a product of type i can be represented as a data structure that stores a list of unique IDs of components (e.g. any infrastructure elements, and optionally the source) that are needed to provide a product at any of the locations l of consumer elements, which locations l are members of the set L of all locations. The components referenced by the recipe may not all carry/source the same volume/quantity of product in a potential solution for providing a product from the source to a consumer element, and to accommodate this the recipe can also comprise volume or capacity weightings (the default weighting is 1). In response to a component or agent indicating a wish to arrange provision of a product of type i to a consumer element at location l, a recipe can be queried by an entity (such as a “solution engine” as described later below), which query returns a potential solution comprising at least:
a set of zero or more infrastructure elements' types k and locations l, and
a volume or capacity weightings vector R
optionally information regarding the source

πᵢ(l)=({(k₁,l₁),(k₂,l₂), . . . },R=(Rₖ_{₁},Rₖ_{₂}, . . . ))

### Smart Grids

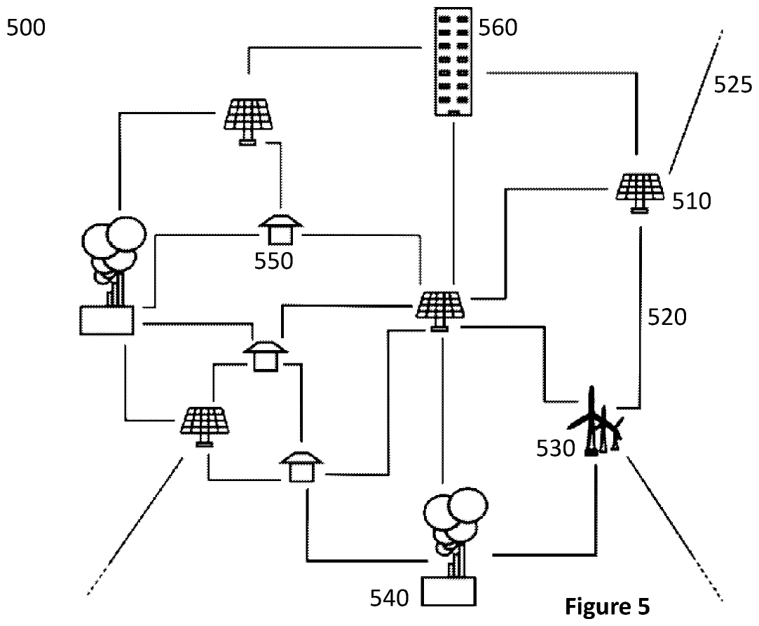

As shown in FIG. 5, a utility network can be connected as a grid network 500, rather than the simple tree shown in FIGS. 1 to 3. FIG. 5 shows solar power generator sources 510, infrastructure elements 520, 525 (e.g. intra-grid connections such as elements 520, and inter-grid connections such as transmission lines 525), wind powered generator source 530, industrial consumer elements 540, transformers 550, and residential consumer element 560.

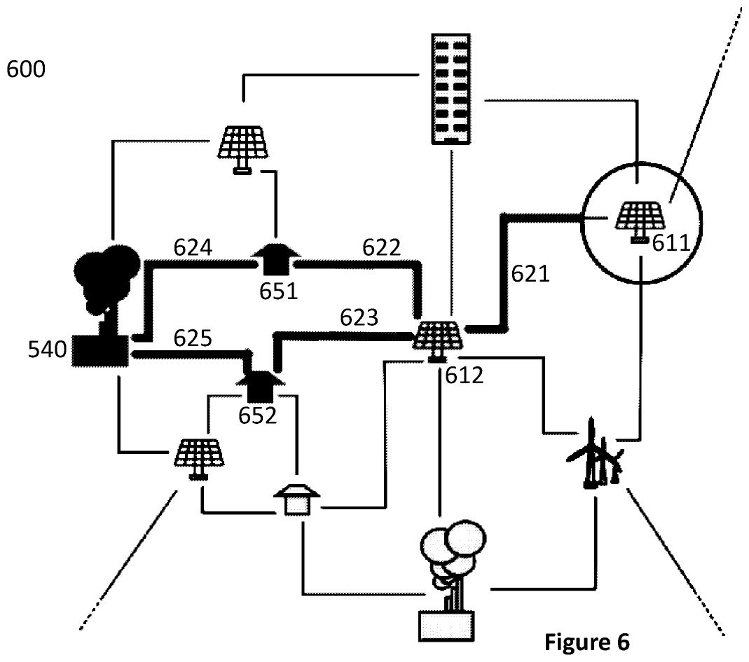

FIG. 6 shows the utility grid network of FIG. 5 wherein source 611, connection infrastructure elements 621, 622, 623, 624, 625, transformer infrastructure elements 651, 652, and industrial consumer element 540 have all been allocated to the supply of a utility product from source 611 to industrial consumer element 540. In cases such as this example where there are two paths, the capacity weighting R can be different (e.g. depending on the components' respective electrical properties) for each path, e.g. in this example, R is 0.7 for components 622, 651 and 624, and R is 0.3 for components 623, 652 and 625. The total of the capacity weightings for all of the paths between the source 612 and the consumer element 540 is 1.

As mentioned, in order to determine those infrastructure elements (if any) needed for providing the utility product from the source 611 to the consumer element 540, the recipe which is known by the source 611 can be queried and one or more potential solutions (such as a solution comprising the highlighted components in FIG. 6) can be determined therefrom. Determining each solution involves traversing at least one path from the source 611 to the consumer element 540, based on the location l of the consumer element 540. Where multiple paths involving multiple potential infrastructure elements are possible, and/or where multiple sources are possible, and/or where multiple weighted combinations of those multiple sources/infrastructure elements are possible, each combination can constitute one of a set of potential solutions. Each source and infrastructure element can have associated conditions, such as maximum utility volume that they can carry and a required cost (e.g. a cost per unit of utility and/or a cost per time unit and/or a fixed cost) for their participation in the provision of a utility product. Those values can be comprised in and/or verified against each potential solution, and an overall cost of each solution and a maximum capacity of that solution can be determined. Each consumer element can also have associated conditions, such as a maximum cost that it is prepared to pay for the provision of utility product to it, and a minimum volume of utility that it needs. Thus, for each potential path (or “solution”) linking a source to a consumer element, only those paths which meet the conditions (e.g. volume and cost constraints) associated with all of the components in the solution can be selected from as potential solutions for providing the utility product. If more than one potential solution is found then a first criterion can be applied to select one or more of those potential solutions for further consideration. The first criterion can comprise one or more of: a lowest solution cost, a highest remaining spare capacity for components used in the solution, and a most evenly balanced capacity usage between components used in the solution. The selected solutions are then stored in a first data store for further consideration by an umpire module, which will be described in more detail further below.

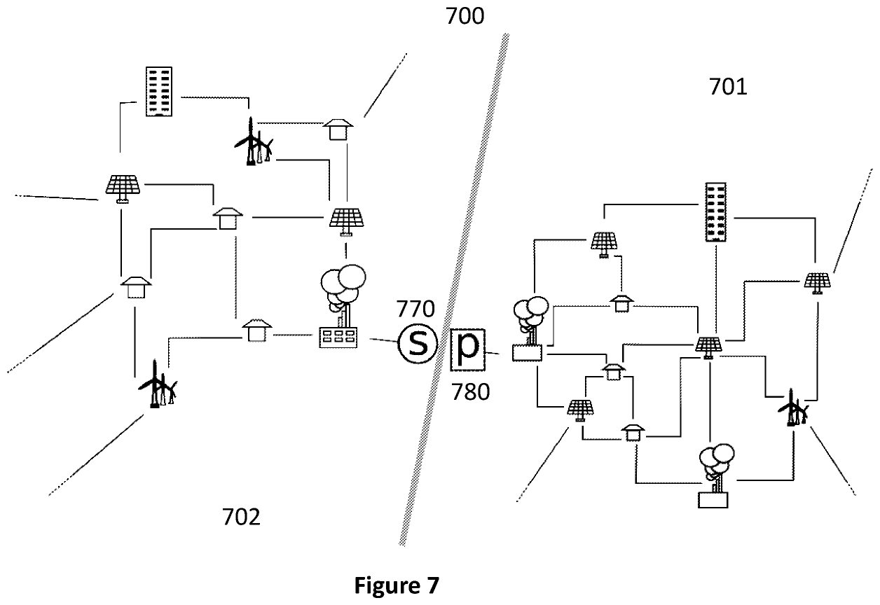

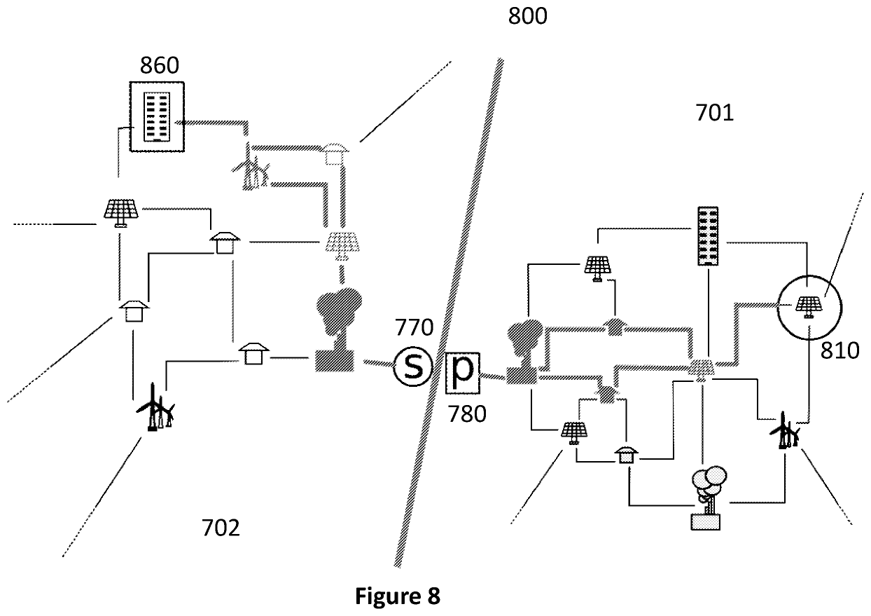

In a grid network 500, 600, such as that shown in FIGS. 5 and 6, as the number of components comprised in the network rises, the computational complexity of determining potential solutions rises at a rate that is greater than a linear relationship. It is therefore advantageous to split a larger network 700 into two or more sub-networks 701, 702 as shown in FIG. 7. This is also advantageous for situations where a utility product is provided in a peer-to-peer manner, between a source and consumer element that are both local to a sub-network, in which case other sub-networks can be agnostic of the provision of utility carried between that local source and that local consumer element, thereby simplifying computation. Connections between two sub-networks can be incorporated by conceptualising a “virtual source” 770 and a “virtual product” 780. In the first sub-network 701, a solution can be determined for delivering product from a source to the virtual product 780, and correspondingly in the second sub-network 702 a solution can be determined for delivering product from the virtual source 770 to a consumer element. The volume/timescale and other factors relating to the product delivered to the virtual product 780 are the same as those factors relating to the product delivered from the virtual source 770. This is visualised in FIG. 8. Further, a network can be subdivided into a greater number of sub-networks than 2 sub-networks. Furthermore, a sub-network can itself be sub-divided into 2 or more sub-networks, and so on. By successively sub-dividing a network in this way, each sub-network can be small enough such that it becomes more computationally practical to determine a sub-solution within that sub-network. Each sub-solution can then be joined together at the sub-network boundaries using virtual products 780 and virtual sources 770, so as to determine an overall solution for the overall network. Due to the greater-than-linear way in which computational complexity of a solution increases as the number of components in a network increases, by sub-dividing the network in this way the computational complexity of determining the solution for the whole network is reduced.

Having described the arrangement of components in a utility service network, and how potential solutions can be determined for providing a utility product from a source to a consumer element within those networks, a further problem can now be considered, that of how to efficiently, accurately and effectively: determine and propose solutions, verify their suitability, select a solution, and allocate network resources according to the selected solution.

### An Allocation Platform

Existing methods and systems have allowed network components to indicate a wish to participate in delivery of a utility product from a source to a consumer element, have matched consumer elements with sources, and optionally infrastructure elements, to some degree, and have recorded matches thereby allocating components for product provision. However, such existing methods and systems have proved unsatisfactory for a number of reasons.

Firstly, in order to provide security against tampering with allocation records, most existing systems have been implemented as centralised systems and/or black box systems with no public visibility of records within such a system. Furthermore, such centralised systems are typically controlled by a single entity, and that entity controls the rules to which components must agree if they are to be allowed to participate in provision of products, and also the rules which are used for selecting components for participation in product provision. Such rules are not always transparent to the components that wish to participate, and as such are not always verifiable to be fair and/or efficient. In addition, due to the centralised nature of such systems, all of the computing power needed to select components for providing product is located within the centralised system, and a problem of a lack of scalability of computing power exists which may lead to sub-optimal selection algorithms being used and thus sub-optimal selections being made. Furthermore, the centralised nature of existing systems makes them inflexible, and vulnerable to DDoS (distributed denial of service) attacks, power outages, and data loss etc. The present disclosure addresses these and other problems, by providing a decentralised system for resource allocation in a utility network.

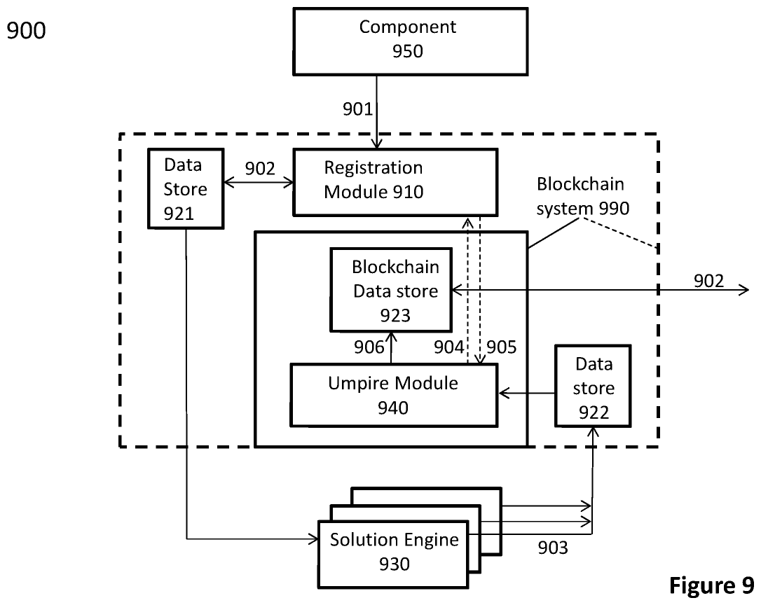

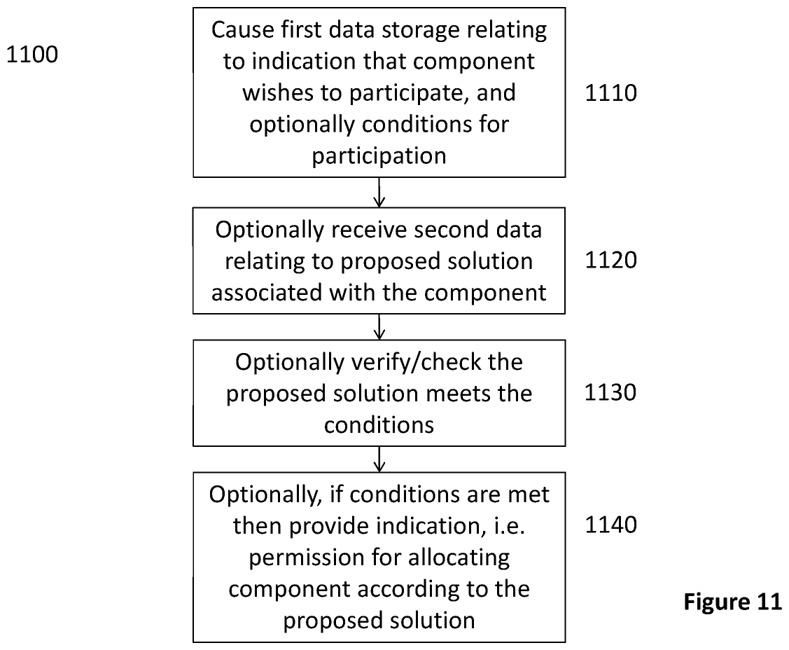

As shown in FIG. 9, with reference also to FIGS. 11 to 13, a system 900 for resource allocation in a utility service network comprises a registration module 910, first and second data stores 921, 922, a blockchain data store 923, one or more solution engines 930, and an umpire module 940. The blockchain data store 923 and the umpire module 940 are comprised within a blockchain system 990, the outline of which is shown in FIG. 9 using a solid line. The dotted blockchain system outline indicates that optionally the blockchain system 990 can also comprise the first data store 921 and registration module 910, and/or optionally can comprise the second data store 922. It will be appreciated that the functionality of the modules described herein can be combined and/or substituted where it does not affect the function of the modules and/or system.

The solution engines 930 are advantageously implemented outside of the blockchain system 990 since the computation carried out by the solution engines 930 is relatively highly complex and is more efficiently carried out outside the blockchain system. This is at least partly because every node of a blockchain system is required to run every on-blockchain calculation, e.g. for verification purposes and to ensure that every node remains in lock-step with the others. This means that there is a great deal of duplication of the calculations. By carrying out solution engine processing off-blockchain, advantages of scalability and processing speed are realised since each solution engine can operate independently.

The registration module 910 and/or the first data store 921 can detect indications from one or more components 950 (or their agents) of the utility service network 200 that those components wish to participate in provision of a utility product from a source component 210 to a consumer element 240, for example via zero or more infrastructure elements 220, 230. Such components can include one or more sources that indicate that they wish to provide a product, and optionally a number of infrastructure elements indicating that they wish to carry such product from a source to a consumer element. Such components can also include consumer elements indicating that they wish to be provided with a product at their location, and/or an agent acting on behalf of a consumer element and indicating a wish for product to be provided to the consumer element at its location. Agents can also indicate participation wishes on behalf of sources and/or infrastructure elements, and can optionally indicate participation wishes on behalf of groups of components that do not participate individually but can participate as a group.

Consumer elements with DSR (Demand Side Response) capability and/or DSR Controllers can also indicate a wish to participate, effectively as a type of source, in providing a product to another consumer element. DSR Controllers can participate in this way by providing a reduction in consumption demand for a particular time period or when issuing a signal (which reduction will be delivered by cooperating with DSR-capable consumer elements that have indicated a wish to participate by providing such a reduction in demand). Such reduction in demand is at the DSR consumer element's location, and is in respect of a particular time period or in response to a signal. As described later, the solution engines 930 will subsequently attempt to match stored first data corresponding to the DSR Controller's wish to participate, with stored first data corresponding to DSR-capable consumer elements' wishes to participate, and if DSR-capable consumer elements can be found to match the DSR Controller's wish then those elements can participate in sourcing of product by the DSR controller.

Indications relating to sources (including DSR controllers), infrastructure elements, and DSR-capable consumer elements that wish to provide product can be represented as positive quantities, whereas indications relating to consumer elements wishing to consume product can be represented as negative quantities, or vice versa. Information regarding the sets of products P that can be composed, infrastructure elements C, and sources S, as well as minimum and maximum time units can be shared between all system elements.

Referring specifically to FIGS. 9 and 11, in response to such an indication from a component, the registration module 910 and/or the component causes (either directly or indirectly) first data associated with the component, and relating to the indication, to be stored 1110 in the first data store 921. In some embodiments the registration module 910 receives the indication from the component and causes the storing, while in other embodiments the component causes the storing, which action is detected by the registration module 910 and taken as the indication. In embodiments, the first data, or data derived from it by processing the first data with a cryptographic operation, is caused to be stored in the first data store. In other embodiments, the causing is either by directly storing, or by instructing another element to do the storing.

In embodiments, the first data (Oₚ) comprises at least: a product, component or source type ID i, a minimum (or maximum) offered cost per-unit-volume-per-unit-time q^{min(max)} (i.e. a minimum cost required by sources/infrastructure elements/DSR-capable consumer elements wishing to supply product, or a maximum cost for consumer elements wishing to be supplied with product), a maximum volume amount u^{max}, and start and end times for which the provision of product is to occur, and can be written as:

Oₚ:=(I,q^{min(max)},u^{max},tₛ,tₑ)

To further explain the above: in some embodiments a consumer element is provided with product from a source, and compensates the source and optionally a number of infrastructure elements with a maximum cost that the consumer element offers for the product provision; however in other embodiments such as when a DSR-capable consumer element provides a Demand Side Response to a DSR Controller type of source, the DSR-capable consumer element can require a minimum cost as compensation for doing so, which is typically met by the DSR Controller.

Variations on the above example of first data are possible, by addition or omission, such as a minimum volume for sources and/or infrastructure elements. A null indication can also be defined as a zero cost offer by a consumer element (which indicates that the component will not contribute to a total cost, but does not prevent inclusion of that consumer element in a solution where cost of product provision is being collaboratively met by multiple components) and an infinite cost offer by a source and/or infrastructure element (which indicates that the product cannot be provided by that component and will prevent inclusion of that component in a solution).

As mentioned in brief above, a component can be one of a source, an infrastructure element, and a consumer element. A source can participate in providing a utility product from a source to a consumer element by generating all or part of the utility to be delivered, or providing it by other means such as by comprising a DSR controller 310 that negotiates a demand reduction. An infrastructure element can participate in such provision by carrying all or part of the utility product from the source to the consumer element. A consumer element can participate by consuming all or part of a utility product, or if it has DSR (Demand Side Response) capability the DSR-capable consumer element can participate by agreeing to reduce (or cease) consumption during an agreed time period, e.g. as agreed with a DSR controller 310 or in response to a signal from the DSR controller 310. As such, there may be a respective provision cost demanded by (or “benefit” received by) sources, infrastructure elements, and consumer elements with DSR capability. On the other hand there may be a consumption cost offered by a consumer element wishing to consume product.

Optionally, the indication from a component can include conditions, such as a minimum cost demanded and/or maximum utility amount (in the case of a source or infrastructure element, or a consumer component offering Demand Side Response), or such as a maximum cost offered and/or minimum utility amount (in the case of a consumer component requiring provision of product to it), which conditions must be met if the component is to agree to participate in any proposed solution including it. The registration module 910 and/or component can optionally cause those conditions associated with the indicating component to be stored 1110 in the first data store 921.

Optionally, program code can be associated with the conditions, which program code is arranged to detect or receive 1120 data relating to a proposed solution associated with the indicating component for providing the product, verify/check 1130 the conditions are met by the proposed solution, and if the conditions are met (positive verification) then provide 1140 an indication (e.g. to the umpire module 940) that the conditions for that component are met and thus permission is granted for that solution to be used to allocate the indicating component for providing the product.

Optionally, the first data store 921 can be implemented in a blockchain system, such as the blockchain system 990. When the first data store 921 is implemented in a blockchain system and the first data comprises such program code, the program code can be executed by the blockchain system, and program state information can be stored with the first data, such that the blockchain system operating as a virtual machine can receive 1120 a proposed solution for providing the product, verify/check 1130 the conditions specified by the component, and if the conditions are met then provide 1140 permission for resource allocation, without a need for additional computing hardware. Alternatively, the particular component could itself verify its conditions.

Optionally, when the first data store is implemented in a blockchain system, program code can be incorporated in the first data store 921 to implement one or more control mechanisms. For example, first data incorporating such program code, stored in response to an indication that a DSR-capable consumer element (e.g. a consumer element associated with an electric vehicle charger) wishes to participate, can respond to a change in conditions associated with a source included in a potential solution by modifying its own conditions such that it re-schedules or reduces its consumption. For example, in response to a raising of a source's cost requirement, first data associated with a DSR-capable consumer element could autonomously re-schedule that component's desired participation to another time where cost and/or capacity requirements may be lower.

Optionally, such a DSR-capable consumer element can re-schedule its consumption based on a signal received from a DSR controller 310. Such a DSR controller 310 can, according to embodiments, be implemented in a blockchain system such as a blockchain embodiment of the first data store 921 and/or registration module 910, or can be implemented in another blockchain data store such as the second data store 922 or blockchain data store 923, or can be implemented outside of any blockchain system. Such DSR operation can help to reduce peak operating capacity usage, thereby reducing component stress and associated maintenance costs, and increasing reliability/longevity of components.

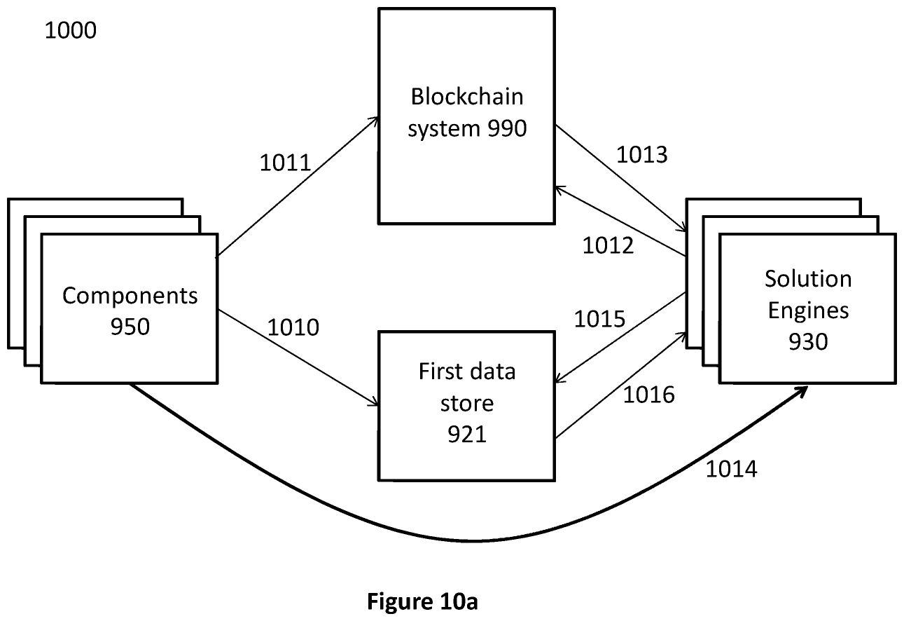

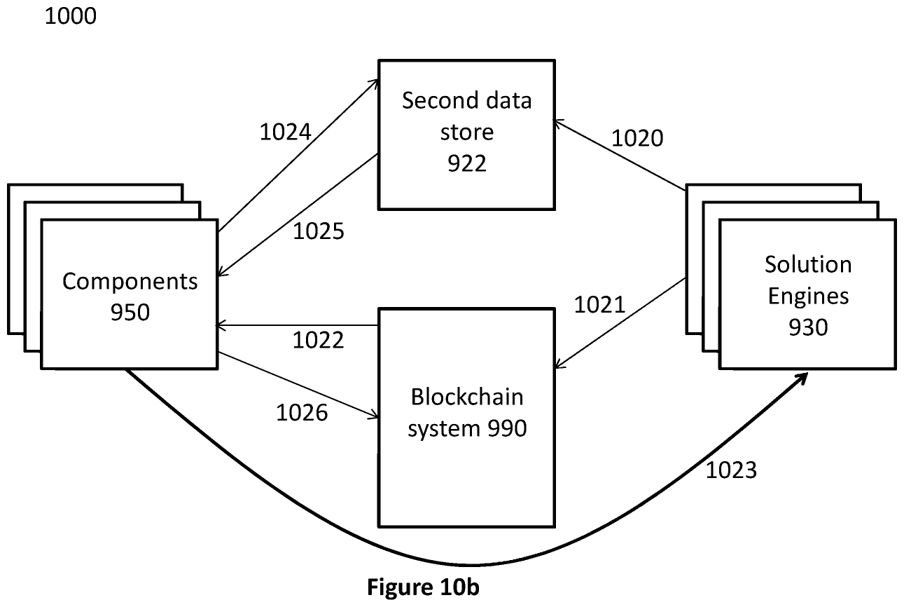

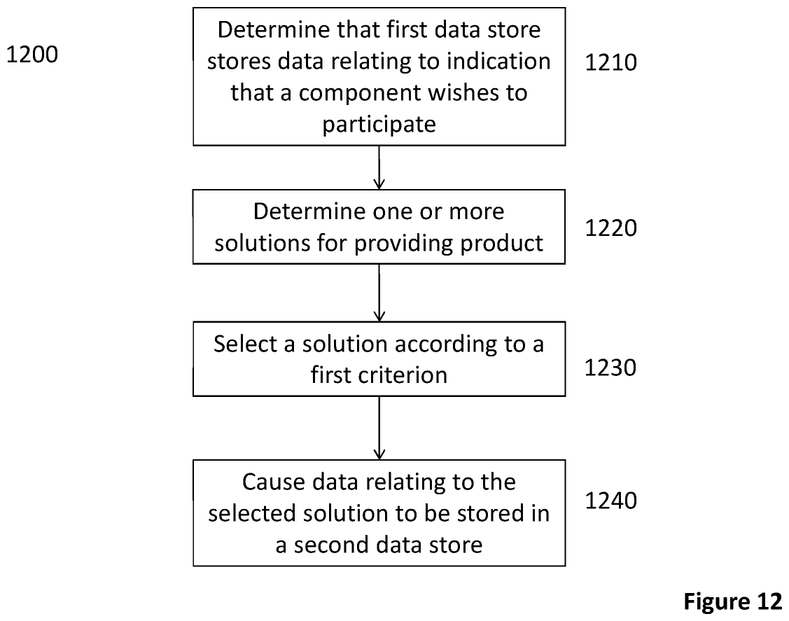

Referring now to FIGS. 9 and 12, Each solution engine 930 can determine 1210 that the first data store 921 stores such first data as described above, associated with a component and relating to an indication that the component wishes to participate in provision of a utility product from a source to a consumer element. Such a determination can be achieved by the respective solution engine 930 examining the content of the first data store 921, or by another module examining said content, or by the first data store 921 or blockchain system 990 providing an indication to the solution engine 930, or by other suitable means. Optionally each solution engine 930 may be required to register its wish to provide solutions before being able to do so, for example solution engines 930 can do this, in embodiments, by performing a transaction on the blockchain data store 923 resulting in them being given access to the first data store 921 (e.g. by virtue of being given a cryptographic key with which to decrypt the first data)—as later described with reference to FIGS. 10a and 10b.

Responsive to such determining, the respective solution engine 930 determines 1220 one or more solutions for providing said utility product, each solution comprising information relating to a plurality of components, including the component which indicated that it wished to participate, which components can participate to facilitate the provision of the utility product. For example, a solution engine 930 can begin by determining that the first data store 921 stores first data relating to an indication that a consumer element wishes to be provided with a product, and then query recipes of connected source components to determine one or more solutions each involving a source, and optionally infrastructure elements, that have indicated a wish to provide sufficient quantity of product to meet the consumer element's desired quantity. Alternatively, the solution engine 930 can begin by determining that the first data store 921 stores first data relating to an indication that a source wishes to provide a quantity of product, and then query the source's recipe(s) to find connected consumer elements that have indicated a desire to be provided with a compatible quantity of product. Determining solutions can be achieved as described in the previous paragraphs with reference to FIGS. 1 to 8. In the case of a source being a DSR Controller, the solution engine 930 can additionally attempt to match one or more DSR-capable consumer elements to a quantity of consumption reduction (corresponding to a quantity/amount of product) that the DSR Controller has indicated that it wishes to provide, such that the DSR Controller can effectively act as a source that is capable of providing that quantity/amount of product. Alternatively, the DSR-Controller can negotiate with DSR-capable consumer elements by other means before indicating its wish to participate.

Having determined one or more solutions, the solution engine 930 selects 1230 a solution according to a first criterion, so as to choose an optimal solution according to that criterion. In embodiments, the first criterion comprises one or more of the following requirements:
the components used to create the product must match the source's recipe for the product;
the first data must relate to a multiple of an allocation time unit;
the product/infrastructure elements/source must have first data relating to indications for the same times, such that the period between the start time and end time is exactly covered;
the proposed volumes/quantities of the product and source must be the same;
the proposed volumes/quantities of the components must be specified as the correct multiples of the product volume/quantity, according to the volume/capacity weighting vector R of the recipe;
the cost offered for a product by a consumer element must equal or exceed the sum of the prices demanded by the source and any infrastructure elements.

The first criterion can additionally comprise factors including one or more of: a lowest solution cost, a highest remaining spare capacity for components used in the solution, and a most evenly balanced capacity usage between components used in the solution, and/or other appropriate factors.

The solution engine 930 then causes an entry of second data relating to the selected solution to be stored 1240 in the second data store 922. In embodiments, the second data (T) comprises a set of (i.e. one or more groups of the following): a first data entry relating to a component involved in the solution; a volume u, and a price per-unit-volume-per-unit-time q. This can be denoted as:

T={(Oₚ,uₚ,qₚ),(O_{c}_{₁},u_{c}_{₁},q_{c}_{₁}),(O_{c}_{₂},u_{c}_{₁},q_{c}_{₁}), . . . }

Advantageously, multiple solution engines 930 can operate concurrently, determining solutions and causing entries of second data relating to those solutions to be stored (either directly or indirectly) in the second data store 923 for consideration by the umpire module 940. In embodiments, a single or multiple second data stores 922 can be employed.

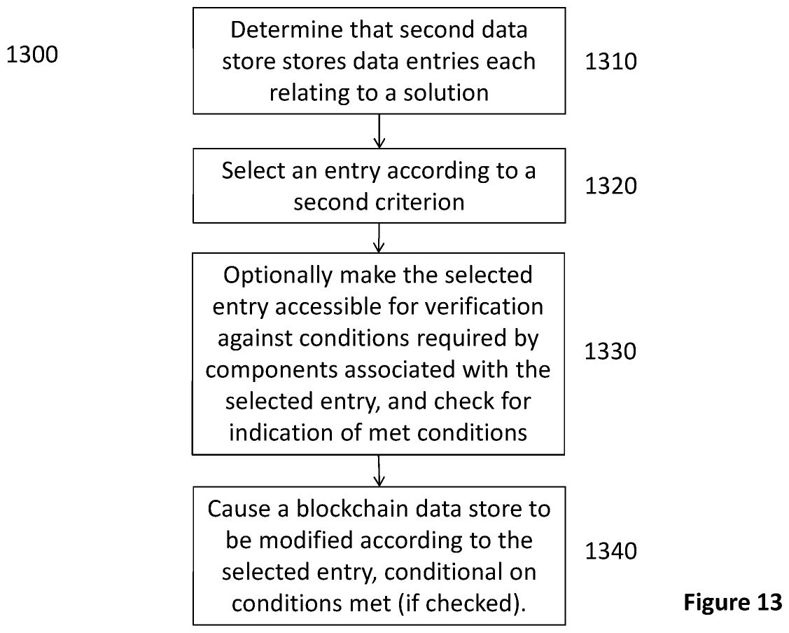

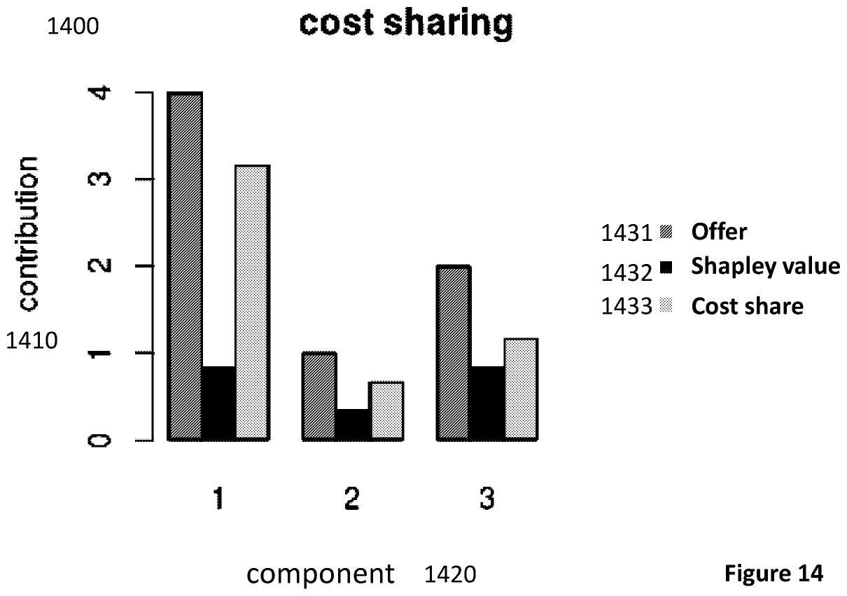

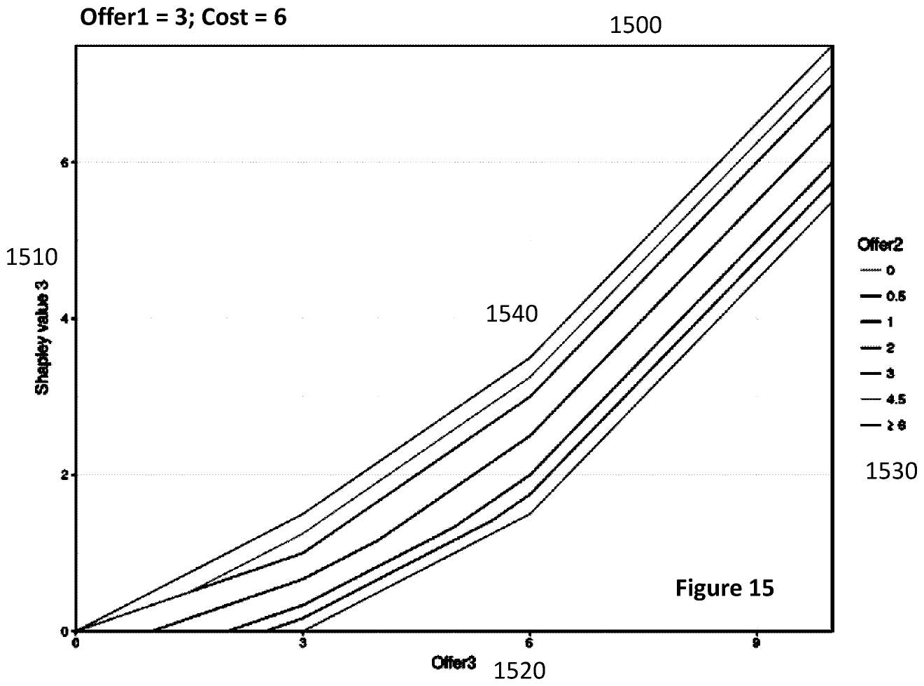

Referring to FIGS. 9 and 13, the umpire module 940 can determine 1310 that the second data store 922 stores such entries of second data as described above, and responsive to such a determination, selects 1320 one of the stored entries of second data according to a second criterion. In embodiments, the second criterion includes one or more of: greatest surplus per-unit-volume; greatest total volume provided; similarity of allocations of cost and/or capacity surpluses in the proposed solutions to calculated Shapley Values (calculated as described herein with reference to FIGS. 14 and 15); and/or a combination of these factors (e.g. surplus-per-unit-volume×total volume). In addition, it is possible for the rules that the umpire module 940 applies to be updated from time-to-time, and, due to the architecture of the system and methods described herein, that can be achieved with minimal disruption. Furthermore, in embodiments, multiple umpire modules 940 can be employed, each potentially using different rules. In some embodiments, the solution engine 930 which proposed the solution related to the selected second data entry may receive a reward.

Optionally, the umpire module 940 then makes accessible (or “proposes”) 1330 the selected entry of second data for verification/validation against the respective conditions required by the components associated with the selected solution. This is to check that each component approves of the associated solution and that the solution is valid, before the selected second data (or data derived therefrom) is finally recorded on the blockchain data store and thus becomes a record of a commitment to allocate resources accordingly. In embodiments, validity checks including the following are made, and if any check fails then the proposed solution related to the respective entry of second data is rejected:

an entry of second data is rejected if it relates to a proposed solution where a provision cost is greater than a cost that a consumer element indicated they wished to participate at, or where a provision cost is lower than a source, infrastructure element or DSR consumer element indicated they wished to participate at;

an entry of second data is rejected if it proposes greater provision of product volume than was offered by a source or its agent;

an entry of second data is rejected if it proposes provision of an invalid volume of product or provision for an invalid time period (taking into account the recipe's volume weightings).

To carry out this optional proposal/validation process, the umpire module 940 makes accessible the selected entry of second data, e.g. to registration module 910 and/or the relevant component and/or first data store 921. This making accessible can include transmitting the selected entry of second data to the registration module 910, or placing the selected entry in a memory that is accessible to the registration module 910, or other means of making the selected entry accessible (to whichever element is performing the verification) such that verification can be carried out of whether the second entry of second data meets the conditions specified by the components and store in the first data store 921. As discussed, such verification can be carried out by the registration module 910, and/or by program code stored in the first data store 921 and executed by a blockchain system in which the first data store 921 is comprised, and/or by the relevant component itself. By implementing the first data store using blockchain techniques and incorporating program code with the first data, the first data can check for itself whether proposed solutions meet conditions required by the components which have indicated that they wish to participate. This relieves the components themselves from having to check their conditions against proposed solutions, and thus allows automated checking of conditions in a scalable manner, without necessarily requiring additional computing resources. In such embodiments which verify conditions, the umpire module checks 1330 for receipt of an indication that the conditions are met by the selected entry of second data, before causing 1340 the blockchain data store to be modified according to the selected entry of second data. In alternative embodiments, the proposing 1330 can be carried out before the selecting 1320, e.g. such as when a solution engine 930 causes 1240 a second data entry to be stored in the second data store 922, it may inform the umpire module 940 (or another module in the blockchain system 990) that it has done so, in order that such a module can perform verification of the potential solution associated with that second data entry.

Subsequent to selecting 1320 one of the entries of second data, the umpire module 940 causes 1340 the blockchain data store 923 to be modified according to the selected entry of second data. As mentioned, in embodiments where the umpire module 940 proposes 1330 the selected entry of second data for verification against the conditions of the components, the causing 1340 the blockchain data store 923 to be modified is conditional upon receiving an indication that the conditions are met by the selected entry of second data. The modification of the blockchain data store 923 corresponds to a commitment that the resources associated with the solution related to the selected second data are allocated for providing the utility product from the associated source to the associated consumer element, e.g. in embodiments, at the specified volume and time period. Such a modification is, by way of example, performed based on the selected entry of second data, but need not be (and is preferably not) performed such that the blockchain data store actually comprises the selected entry of second data (since such selected entry may in some cases be wished to be kept secret). Instead, in such embodiments, the blockchain can be modified according to the selected entry of second data such that check data of the selected entry of second data can be retrieved by authorised parties from the blockchain, and used to verify the commitment to allocation, e.g. without revealing potentially private content of the selected entry of second data.

Although the above-described methods and system have been described in terms of separate cooperating modules, some or all of the modules can be co-located in a single or fewer modules, and it will be understood that the described module boundaries are conceptual rather than limiting. It will be apparent that the first data store 921 can optionally be integrated with the registration module 910, and/or the registration module 910 can be implemented in the blockchain system 990 or another blockchain system. Further, the second data store 922 can be integrated with the blockchain system 990 and optionally the umpire module 940, or with another blockchain system, and the blockchain data store 923 can be operated on directly and/or indirectly by the umpire module 940 via an intermediary. Furthermore, an “Initial Transparency” module (not shown) can provide an interface by which components can apply to register their wish to participate in utility product provision, and an “Allocation auditing” module (also not shown) can provide an interface by which third parties can examine and verify allocations recorded in the blockchain data store 923 according to a verification criteria—such as successful verification of a result of a cryptographic operation. Access rights to the first data store 921, second data store 922, and blockchain data store 923 can be stored in the blockchain data store 923, e.g. under control of the umpire module 940, or securely in other storage means. It will be understood that the described method steps can be performed by the above-described separated modules, or can be performed by greater or fewer modules, or by a single module, the dependencies between method steps being clear based on their prerequisites and results. It will be seen that the above-described methods and systems are more flexible than existing techniques, and by their decentralised nature are more scalable, more reliable and more resistant to DDoS attacks.

Shown in FIGS. 10a and 10b is an example of a system 1000 according to an embodiment of the above disclosure with reference to FIG. 9, showing additional detail on transactions carried out between the modules.

Turning first to FIG. 10a, in a first step 1010, in response to an indication that a component 950 wishes to participate in provision of a product, first data relating to the indication is caused to be stored in the first data store 921. This can be done by the component 950, and/or by registration module 910, but for simplicity in this example is shown being done by (or on behalf of) the component 950. Such first data can be encrypted, needing decryption key K1 in order that it can be decrypted. In step 1011 of this example, “check data” derived from the first data (e.g. a hash of the first data) and an address within the first data store 921 where the first data can be found, is given to the blockchain system 990. Such check data has the properties that 1) it does not reveal the content (which may be private) of the data from which it is derived, and 2) can be used to prove that the data from which it is derived has not changed since the check data was given to the blockchain system 990. Although a hashing function is one example of a suitable way that check data can be derived, other methods are possible. At step 1012, a solution engine 930 can request permission to see the content of the first data store 921. At step 1013, the check data and the address are sent by the blockchain system 990 to authorised solution engines 930. At step 1014, the component 950, its agent, or another intermediary such as the registration module 910, sends the decryption key K1 to each authorised solution engine 930, e.g. using the respective solution engine's public key. When a solution engine 930 wishes to start work on a solution, e.g. in response to receiving the check data and address of the first data, it can send 1015 the address of the first data to the first data store 921, and in response thereto receives 1016 the first data. Solution engines 930 can obtain first data relating to multiple components in this way, and then carry out the necessary operations to arrive at proposed solutions.

Turning to FIG. 10b, having determined 1220 and selected 1230 a potential solution, a solution engine 930 causes a second data entry related to the selected solution to be stored 1020 in the second data store 922. The second data entry is preferably encrypted using a key such that it is decryptable using decryption key K2. At step 1021, further check data (derived from the second data entry), and an address of the second data entry within the second data store 922, and optionally a “utility value” which can be used as the basis of the second criteria described earlier, are sent to the blockchain system 960 (e.g. to the umpire module 940). A component 950 participating in a proposed solution relating to the second data entry receives the further check data and the database address at step 1022. At step 1023 the component 950 also receives the decryption key K2, which can e.g. be securely sent to the component 950 using its public key. Advantageously, in embodiments, each component 950 receives only those keys K2 which relate to proposed solutions involving that respective component, hence components cannot access information relating to proposed solutions in which they would not play any part. At step 1024 the component 950 (or whichever element is performing the verification, e.g. the first data store 921) uses the database address to look-up and receive 1025 the associated entry of second data for verification. By such steps, or by other suitable means, the entry of second data is made accessible for verification. As mentioned earlier, this verification can be performed by the component 950, or in other embodiments can be performed by program code associated with the component's first data in the first data store 921 and executed by the (or another) blockchain system 990, in which case the destination of the second data entry would be adjusted appropriately. The verification is then performed, and if the solution associated with the second data entry is valid, according to a predetermined verification criteria, then at step 1026 an indication of successful verification is sent to the blockchain system 990. Subject to successful verification, the blockchain system (specifically, the umpire module 940 within the blockchain system 990) can then select, according to the second criterion as mentioned above, a solution based on the verified second data entry to be used for allocating resources, and can record data derived from the selected solution in the blockchain data store.

By virtue of the above-described methods and systems, it is made possible for a plurality of solution engines 930 to independently determine solutions for providing utility products from a source to a consumer element, which solution engines 930 need not be under the control of a single entity nor implemented in a single black box system. This is facilitated in that each solution engine 930 is able to determine that first data relating to wishes of components to participate in utility product provision exists in the first data store, and each solution engine 930 is able to submit its proposed solutions to the umpire component 940 for consideration and selection, in a verifiable and tamper-proof manner.

The umpire module 940 and the blockchain data store which stores data relating to allocation commitments are implemented in a blockchain system, which has the advantageous properties that it is inspectable by all parties authorised to interact with the blockchain, and yet is secure against tampering. For example, a blockchain could be publically accessible, or could be a blockchain that is protected by one or more cryptographic keys, such that its content is hidden from the general public but is accessible to any party that has been authorised by providing them with the cryptographic key(s) needed to interact with the blockchain. By incorporating program code that implements the umpire module 940 within a blockchain data store (e.g. by implementing the second data store 922 using blockchain techniques and incorporating such program code therein), the umpire module code becomes inspectable by any authorised party, and yet tamper proof, and execution of the umpire module code does not require dedicated computing resources since it is executed by the blockchain system. This results in the advantage that the rules that the umpire module 940 uses to select solutions presented by solution engines 930 are visible to all authorised parties and can thereby be seen to be fair and consistent, thereby increasing the likelihood that those rules will be applied fairly and consistently, and thereby increasing the likelihood that rules that select optimal solutions will be applied. Furthermore, the ability of the described system to accommodate multiple solution engines 930 allows computing power to be decentralised, e.g. across multiple sites, and across multiple entities, thereby making the system more scalable, helping to increase the availability of computing power and increasing the availability of algorithms for determining the most optimal solution, while making the system more resistant to DDoS attacks.

### Excess Sharing

A further problem that the present disclosure solves is as follows. In the described utility networks, a plurality of components are involved in delivering a product from a source to a consumer element. As mentioned, some of those components do not compete with each other because, for example referring to FIG. 3, distribution infrastructure element 332 cannot be used as an alternative to distribution infrastructure element 333: they are both required for delivery of utility product to consumer element 340.

In such resource allocation situations, a consumer element 340 may offer a cost C, and the other components involved in supplying the product may demand respective costs (in this example, two source/infrastructure elements demanding costs A and B). If A+B is greater than C then any solution involving those two source/infrastructure elements and that consumer element will be vetoed since the conditions of the components involved will not be met. If A+B=C then the solution can be accepted. If A+B is less than C, then a problem of how to allocate the excess can arise, depending on whether by convention the consumer element keeps the excess, or the source/infrastructure elements keep the excess. If by convention the consumer element keeps the excess then the solution is easy since there is only one consumer element, therefore they keep the whole excess. If by convention the excess is to be shared by the source/infrastructure elements then a fair way of sharing the excess is needed, since: if the first of the two source/infrastructure elements was given all of the excess then over time the second of those components may suffer from reduced maintenance and/or may have to endure a longer service life, and reliability could suffer. A similar situation can occur when a DSR-capable consumer offers a demand reduction in return for a cost C, for which a source offers a cost A and an infrastructure element offers a cost B. If C is less than A+B then a fair way of allocating the saving to the source and the infrastructure element is needed, to avoid one having to shoulder the burden unfairly, with potential resulting reduced maintenance and reliability.

A similar problem exists in the following example: A source 612 supplies a consumer element 540 via two infrastructure elements 651, 652 which share the load between them according to their electrical properties, and which can also supply another consumer element that has DSR capability (not shown in FIG. 6). If the consumer element with DSR capability offers to forego a particular consumption amount, in return for a cost C to be compensated (in this example) by the source and the two infrastructure elements, a problem exists of how to allocate the compensation C between the source and the two infrastructure elements 651, 652. Since each of the source and infrastructure elements benefits from the reduction in demand, in terms of moving each component away from their maximum operating capacities, it is right that each should share in compensating the DSR-capable consumer element—otherwise, those components that contribute unfairly might wear out sooner and yet not appropriately be provided with the costs of meeting maintenance/replacement tasks. For example, if component 651 was required to bear more than its fair share of cost C then it could suffer from reduced maintenance and longer service life, likely resulting in a greater rate of failure. In one example, the DSR-capable consumer element demands a cost C for providing a reduction in supply, the source offers a cost A and the infrastructure elements 651, 652 respectively offer costs of B₁ and B₂. If A+B₁+B₂>C, a method of fairly distributing the excess (excess=C−(A+B₁+B₂)) is required, so as to avoid any of the components involved in the recipe from being unfairly burdened against maintenance and/or replacement costs.

An algorithm satisfying the above requirements is based on a Shapley value calculation. The Shapley value, as shown in the graph 1400 of FIG. 14, as it applies to the present disclosure, attempts to allocate an excess in proportion to the respective values of contribution made by each component to the provision of a utility product. As shown in FIG. 14, components with a relatively high contribution have a relatively high Shapley value, giving them a proportionally high share of any excess.

A further illustration 1500 is shown in FIG. 15, wherein a Shapley value for component 3 (of 3) varies on the Y axis 1510 from 0 to approximately 7, dependent on a cost offered by component 3 (X axis 1520), in the context of a fixed cost of 3 offered by component 1, and seven different cost offers by component 2 which correspond to each of the seven plot lines 1540. The result of such a calculation is that if a particular component offers (or demands) more than its fair share of the cost of providing a utility product then a fair amount is refunded (or deducted) in order that excess cost and/or capacity is fairly and sustainably allocated between each of the components.

The Shapley value can be calculated as follows, where:

N is the set of all components

S is the set of components involved in a potential solution, S being a subset of N

p is the total cost of a product

qᵢ is the offer of component i

Qᵢ is the cost share of component i

surplus is the excess of the sum of offers over the product cost

$$surplus = {\sum }_{i} {q}_{i} - p$$

By way of example, as illustrated in FIG. 14, if S contains 3 components (denoted by σ, Ω, δ—e.g. a source and two infrastructure elements), which wish to collaborate in the provision of a product to a consumer element, and another (DSR-capable) consumer element offers to abstain from consuming product for a cost of 5. In return for this spare capacity, component σ offers a cost of 4, component Ω offers a cost of 1, and component δ offers a cost of 2. As mentioned, the actual cost demanded by the DSR-capable consumer element is 5, therefore the surplus (or “excess”) is 4+1+2−5=2. What is needed is a fair way of allocating, or “giving back”, a fair proportion of the excess to each of the 3 components.

The Shapley Value is a concept described by L.S. Shapley and represents a “payoff vector” reflecting the contribution made by a component to a particular solution, wherein the elements of the vectors correspond to each of the components in the set S which are involved in the particular solution. In essence, the more a component contributes to a particular solution, the greater its share of the surplus. The concept embodies four principles:
Group efficiency—the total surplus is exactly divided between the components;
Symmetry—if the respective contribution to a solution by two different components is the same, then the share of those components is equal;
Dummy component—if the contribution by a component is zero then its share is zero;
Linearity—the sum of shares for two solutions considered separately is equal to the sum of shares for the two solutions considered at the same time.

An equation which can be used to calculate the Shapley Value is as follows:

$${φ}_{i } ( u ) = \frac{1}{n !} {\sum }_{S ⊆ ( N \backslash \{ i \} )} \vert S \vert ! ( n - \vert S \vert - 1 ) ! {Δ}_{S , i}$$

$$i , S ⊆ N$$

Where n is the total number of components, the sum is taken over all possible sets of components S, and

Δ_{S,i}=u(S∪{i})−u(S)

represents the “marginal contributions of component i to solution S.

In the example of FIG. 14, the marginal contributions of component σ are as follows:

Δ_{{σ,σ}=0−0=0,

Δ_{{Ω},σ}=0+0=0,

Δ_{{δ},σ}=1−0=1,

Δ_{{Ω,δ},σ}=2−0=2.
and the Shapley value for component σ is:

$${φ}_{σ} = \frac{1 ! \cdot 1 !}{3 !} \cdot 1 + \frac{2 ! \cdot 0 !}{3 !} \cdot 2 = \frac{1}{6} + \frac{4}{6} = \frac{5}{6}$$

In this example, the offered cost of component σ was 4, therefore the share of component σ is 4−⅚=3⅙. Repeating this for each of the components in this example, the following values are obtained, as illustrated in FIG. 14.

Product cost = 5

| | Offer cost | Shapley | Share |
|---|---|---|---|
| σ | 4 | ⅚ | 3 ⅙ |
| Ω | 1 | 2/6 | 4/6 |
| δ | 2 | ⅚ | 1 ⅙ |

The calculation of the Shapley Value requires a certain number of mathematical operations, in particular, calculation of the characteristic function for every possible set S of components that can be assembled to deliver the product. For n components, there are 2ⁿ combinations that have to be considered, however for the number of components expected to be involved in provision of a utility product (e.g. three or fewer), such a calculation is relatively computationally simple and therefore implementable in a blockchain system, e.g. as a function written in program code, or more practically as look-up tables with predetermined levels of accuracy. Such look-up tables could take the input costs, round them to a predetermined accuracy level, and return the Shapley allocation vector (Q₁, Q₂, . . . , Qₙ). In practice, a cost demanded by a component for participation in provision of a product is likely to be somewhat related to the amount of capacity or product quantity that the component must bear, and therefore the use of the Shapley calculation tends to result in a fair allocation of excess in proportions that are related to the operating capacity of the component, thereby ensuring maintenance costs are met and component longevity is not required to be longer than a period that is consistent with reliability. Of course, any other calculation suitable for relating a component's contribution to its share can be used for allocating excesses, for example a calculation more or less directly based upon component operating capacity values.

A calculation such as the Shapley calculation thus gives a fair and sustainable share of any excess to each component, ensuring that maintenance costs are met. As mentioned, this is especially advantageous in the example case where a DSR-capable consumer element offers a reduction in consumption of utility product (e.g. under control of a Demand Side Response Controller 310) in return for a demanded cost, and infrastructure elements 220, 331 which are collaborating to supply another consumer element 340 collaboratively offer an amount in excess of the demanded cost in return for that reduction in consumption. Similarly, the above method can be used to allocate surplus cost offered by a consumer element in return for consumption of a product, provided by non-competing sources and infrastructure elements, which are collaborating in different (non-rival) roles in a utility service network to provide the product. As mentioned, this can help to ensure more sustainable operating conditions for those sources/infrastructure elements in terms of the meeting of maintenance costs and resultant long-term reliability of those components.

Advantages and technical effects of aspects and embodiments, including those mentioned above, will be apparent to a skilled person from the foregoing description and from the Figures.

It will be appreciated that the described methods can be carried out by one or more computers under control of one or more computer programs arranged to carry out said methods, said computer programs being stored in one or more memories and/or other kinds of computer-readable media.

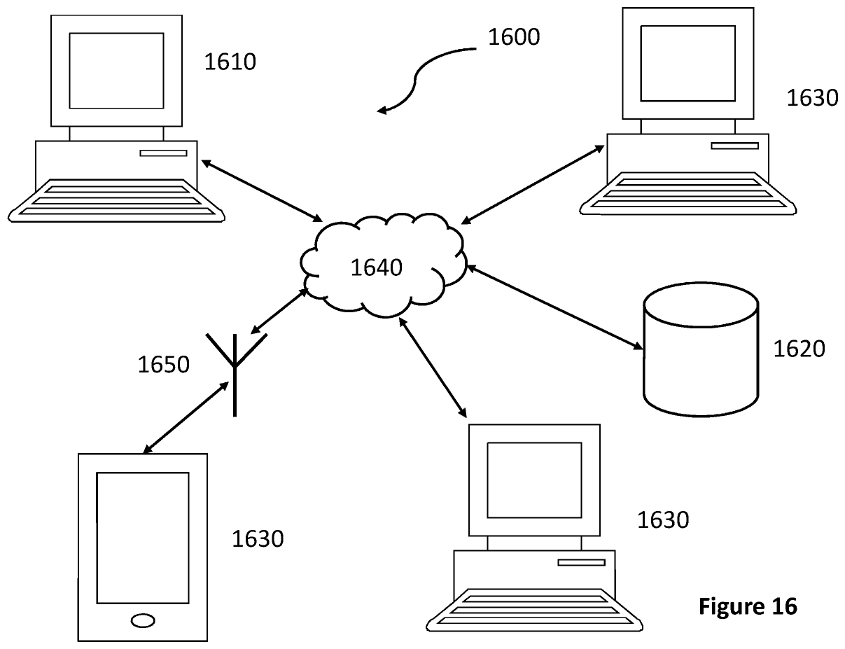

FIG. 16 shows an example of a computer system 1600 which can be used to implement the methods described herein, said computer system 1600 comprising one or more servers 1610, one or more databases 1620, and one or more computing devices 1630, said servers 1610, databases 1620 and computing devices 1630 communicatively coupled with each other by a computer network 1640. The network 1640 may comprise one or more of any kinds of computer network suitable for transmitting or communicating data, for example a local area network, a wide area network, a metropolitan area network, the internet, a wireless communications network 1650, a cable network, a digital broadcast network, a satellite communication network, a telephone network, etc. The computing devices 1630 may be mobile devices, personal computers, or other server computers. Data may also be communicated via a physical computer-readable medium (such as a memory stick, CD, DVD, BluRay disc, etc.), in which case all or part of the network may be omitted.

Each of the one or more servers 1610 and/or computing devices 1630 may operate under control of one or more computer programs arranged to carry out all or a subset of method steps described with reference to any embodiment, thereby interacting with another of the one or more servers 1610 and/or computing devices 1630 so as to collectively carry out the described method steps in conjunction with the one or more databases 1620.

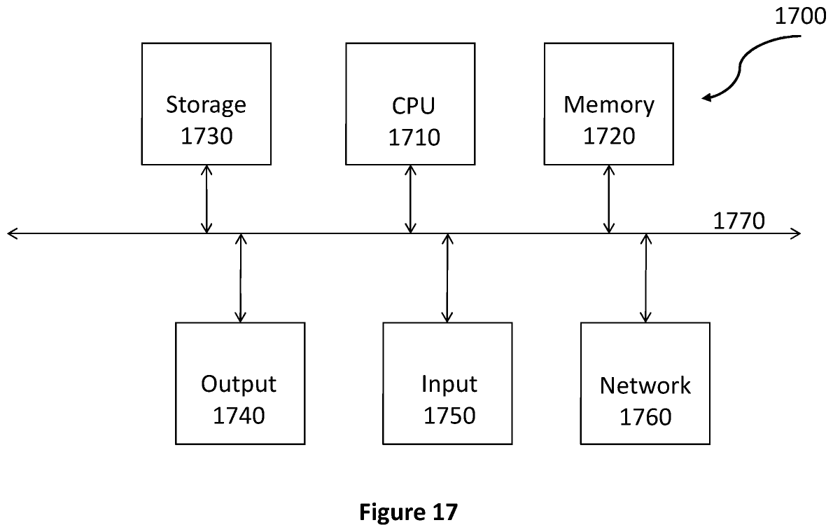

Referring to FIG. 17, each of the one or more servers 1610 and/or computing devices 1630 in FIG. 16 may comprise features as shown therein by way of example. The shown computer system 1700 comprises a processor 1710, memory 1720, computer-readable storage medium 1730, output interface 1740, input interface 1750 and network interface 1760, which can communicate with each other by virtue of one or more data buses 1770. It will be appreciated that one or more of these features may be omitted, depending on the required functionality of said system, and that other computer systems having fewer components or additional/alternative can be used instead, subject to the functionality required for implementing the described methods/systems.

The computer-readable storage medium may be any form of non-volatile and/or non-transitory data storage device such as a magnetic disk (such as a hard drive or a floppy disc) or optical disk (such as a CD-ROM, a DVD-ROM or a BluRay disc), or a memory device (e.g. a ROM, RAM, EEPROM, EPROM, Flash memory or portable/removable memory device) etc., and may store data, application program instructions according to one or more embodiments of the disclosure herein, and/or an operating system. The storage medium may be local to the processor, or may be accessed via a computer network or bus.

The processor may be any apparatus capable of carrying out method steps according to embodiments of the invention, and may for example comprise a single data processing unit or multiple data processing units operating in parallel or in cooperation with each other, or may be implemented as a programmable logic array, graphics processor, or digital signal processor, or a combination thereof.

The input interface is arranged to receive input from a user and provide it to the processor, and may comprise, for example, a mouse (or other pointing device), a keyboard and/or a touchscreen device.

The output interface optionally provides a visual, tactile and/or audible output to a user of the system, under control of the processor.

Finally, the network interface provides for the computer to send/receive data over one or more data communication networks.

Embodiments of the invention may be carried out on any suitable computing or data processing device, such as a server computer, personal computer, mobile smartphone, set top box, smart television, etc. Such a computing device may contain a suitable operating system such as UNIX, Windows® or Linux, for example.

It will be appreciated that the above-described partitioning of functionality can be altered without affecting the functionality of the methods and systems, or their advantages/technical effects. The above-described functional partitioning is presented as an example in order that the invention can be understood, and is thus conceptual rather than limiting, the invention being defined by the appended claims. The skilled person will also appreciate that the described method steps may be combined or carried out in a different order without affecting the advantages and technical effects resulting from the invention as defined in the claims.

It will be further appreciated that the described functionality can be implemented as hardware (for example, using field programmable gate arrays, ASICs or other hardware logic), firmware and/or software modules, or as a mixture of those modules. It will also be appreciated that, a computer-readable storage medium and/or a transmission medium (such as a communications signal, data broadcast, communications link between two or more computers, etc.), carrying a computer program arranged to implement one or more aspects of the invention, may embody aspects of the invention. The term “computer program,” as used herein, refers to a sequence of instructions designed for execution on a computer system, and may include source or object code, one or more functions, modules, executable applications, applets, servlets, libraries, and/or other instructions that are executable by a computer processor.

As will be appreciated by the skilled person, details of the above embodiment may be varied without departing from the scope of the present invention as defined by the appended claims. Many combinations, modifications, or alterations to the features of the above embodiments will be readily apparent to the skilled person and are intended to form part of the disclosure. Any of the features described specifically relating to one embodiment or example may be used in any other embodiment by making appropriate changes as apparent to the skilled person in the light of the above disclosure.

1. A method for resource allocation in a utility service network that comprises, as components, one or more sources, a number of infrastructure elements and one or more consumer elements, the method comprising:
responsive to an indication that a first component wishes to participate in provision of a utility product from a source to a consumer element, causing first data relating to the indication and associated with the first component to be stored in a first data store;
responsive to determining that the first data store stores such first data,
determining one or more solutions for the provision, each solution comprising information relating to a plurality of components including the first component which can participate to facilitate the provision,
selecting one of said solutions according to a first criterion, and
causing a second data entry relating to the selected solution to be stored in a second data store; and
responsive to determining that the second data store stores such second data entries,
selecting one of the entries of second data according to a second criterion, and
causing a blockchain data store to be modified according to the selected entry of second data.

2. A method for resource allocation in a utility service network that comprises, as components, one or more sources, a number of infrastructure elements and one or more consumer elements, the method comprising:
responsive to an indication that a first component wishes to participate in provision of a utility product from a source to a consumer element, causing first data relating to the indication and associated with the first component to be stored in a first data store, wherein the first data comprises one or more conditions required by the first component for its participation in the provision;
responsive to detecting second data relating to a solution for the provision, the solution comprising information relating to a plurality of components including the first component which can participate to facilitate the provision, verifying that the one or more conditions are met by the solution; and
responsive to a positive verification, providing an indication that resources of the component are permitted to be allocated according to the second data.

3. A method for resource allocation in a utility service network that comprises, as components, one or more sources, a number of infrastructure elements and one or more consumer elements, the method comprising:
responsive to determining that a first data store stores first data associated with a first component and relating to an indication that the first component wishes to participate in provision of a utility product from a source to a consumer element:
determining one or more solutions for the provision, each solution comprising information relating to a plurality of components including the first component which can participate to facilitate the provision,
selecting one of said solutions according to a first criterion, and
causing a second data entry relating to the selected solution to be stored in a second data store.

4. A method for resource allocation in a utility service network that comprises, as components, one or more sources, a number of infrastructure elements and one or more consumer elements, the method comprising:
responsive to determining that a second data store stores second data entries, each entry relating to a respective solution comprising information relating to a plurality of components which can participate to facilitate provision of a utility product from a source to a consumer element,
selecting one of the entries of second data according to a second criterion, and
causing a blockchain data store to be modified according to the selected entry of second data.

5. The method of claim 1 or claim 4, further comprising:
making accessible the selected entry of second data for verification of whether the selected entry of second data meets one or more conditions required by the components associated with the selected entry, and
wherein the step of causing a blockchain data store to be modified is conditional upon receiving an indication that such conditions are met by the selected entry.

6. The method of claim 1, further comprising: auditing the blockchain data store to ensure that a record of a selected entry of second data is valid according to a verification criteria.

7. The method of claim 1 or 6, further comprising causing to be stored, in the second data store, one or more further entries of second data each relating to a further selected solution for the provision, prior to the determining that the second data store stores such second data entries.

8. The method of any one of claims 1 and 6 to 7, wherein the first data store and/or the second data store are also implemented using blockchain techniques.

9. The method of any one of claims 1 and 6 to 8, wherein the blockchain data store is separate from the first data store, and/or wherein the blockchain data store is separate from the second data store.

10. The method of any one of claims 1 to 3 and 6 to 9, wherein the first data comprises one or more of: information identifying the first component; information identifying a time period during which the first component wishes to participate in the provision; information relating to a cost or benefit to the first component for participation in the provision; and information identifying a location of the first component.

11. The method of any one of claims 1 to 3 or 6 to 10, wherein the first data comprises one or more conditions required by the first component for its participation in the provision.

12. The method of claim 11 wherein the first data store is implemented using blockchain techniques and the first data comprises executable code arranged to perform verification that a second data entry meets the conditions.

13. The method of any one of claims 11 to 12, wherein the one or more conditions comprise a predetermined time period and a predetermined provision cost at which the first component wishes to participate in the provision of the utility product.

14. The method of any one of claims 11 to 12, wherein the one or more conditions comprise a predetermined benefit which the first component agrees to receive for participating in the provision of the utility product in return for agreeing to not be provided with such a utility product for a predefined time period.

15. The method of claim 13 or 14 wherein the first data store is implemented using blockchain techniques and the first data comprises executable code arranged to modify the conditions required by the first component in response to detecting a change of conditions required by another component.

16. The method of claim 15 wherein in response to a change in a cost associated with participation by the other component in the provision, the executable code modifies the conditions of the first component, and optionally so as to change the time period that the first component wishes to participate in the provision.

17. The method of claim 1 or 3, wherein the determining one or more solutions comprises, for each source of the plurality of components, identifying infrastructure elements associated with the respective source that can participate in the provision of the utility product to a consumer element that is associated with the respective source.

18. The method of claim 17, wherein the determining comprises traversing one or more paths from the respective source to the respective consumer element, and a respective solution comprises information identifying components along the respective path.

19. The method of claim 18, wherein each solution comprises, for each identified source and infrastructure element, one or more of: an identification, a minimum cost per unit, a minimum volume amount, and an indication of a time period.

20. The method of claim 18, wherein each solution comprises, for each identified consumer element, one or more of: an identification, a maximum cost per unit, a maximum volume amount, and an indication of a time period.

21. The method of any one of claims 17 to 20 wherein the first data comprises data and/or executable code for facilitating the determination of the solutions.

22. The method of claim 1 or 3 wherein the first criterion comprises one or more of: a lowest solution cost, a highest remaining spare capacity for components used in the solution, and a most evenly balanced capacity usage between components used in the solution.

23. The method of any one of claims 1 to 22 wherein the second data comprises one or more of:
information identifying components which it is proposed will participate in the provision, the identified components comprising at least one source, a number of infrastructure elements, and at least one consumer element;
information identifying a time period that the utility product is to be provided for; and
for each of the identified components, information relating to one or more of a cost or benefit for the respective entity to participate, a rate and/or volume of utility, and a weighting factor indicating a contribution made to the provision by the respective component.

24. The method of claim 23 wherein infrastructure elements comprise one or more of transmission lines, pipes, power transformers, switches, cables, antennas, balancing, storage and distribution service elements.

25. The method of any one of claims 1 to 24 wherein a component comprises one of: a utility source from which a utility product can be sourced; an infrastructure element which can facilitate the provision of a utility product; a consumer element to which the utility product can be provided; a consumer element which agrees to not be provided with the utility product for a predetermined period; and a consumer element to which the utility product is provided and which agrees to change consumption of the utility product in response to a signal.

26. The method of 1 or 4 wherein one or both of: the step of selecting one of the entries of second data; and the step of causing a blockchain data store to be modified; are carried out under control of program code comprised in the blockchain data store and executed by a processor associated with the blockchain data store.

27. The method of claim 26 wherein the program code further comprises instructions arranged to apportion any excess of: cost or capacity associated with participation in the provision by the consumer element, minus the total of costs or capacity associated with participation by all of the sources and infrastructure elements associated with the selected entry of second data; wherein the excess is apportioned between the components according to a contribution made to the provision by each component; and optionally wherein the excess is apportioned according to a Shapley Value calculation.

28. The method of claim 1 or 4 wherein the second criterion comprises one or more of:
whichever second data entry will satisfy the participation wishes of the greatest number of first components;
whichever second data entry will result in the allocation of the greatest volume of source and/or infrastructure resource;
whichever second data entry will result in the lowest cost per unit of resource supplied; and
whichever second data will result in the greatest level of spare capacity in the components associated with the respective second data entry.

29. The method of any of claims 1 to 28 wherein the utility service network is a first sub-network comprised within a larger utility service network that comprises at least a second sub-network.

30. The method of claim 29 wherein the components of the first sub-network comprise a virtual consumer element, and components of the second sub-network comprise a virtual source, and wherein utility supplied into the second sub-network by the virtual source corresponds with utility consumed from the first sub-network by the virtual consumer.

31. The method of claim 30 wherein each of the first and second sub-networks is similarly sub-divided.

32. An apparatus arranged to carry out a method according to any one of the preceding claims.

33. A system for resource allocation in a utility service network which network comprises, as components, one or more sources, a number of infrastructure elements and one or more consumer elements, the system comprising:
means for, responsive to an indication that a first component wishes to participate in provision of a utility product from a source to a consumer element, causing first data relating to the indication an associated with the first component to be stored in a first data store;
means for determining that the first data store stores such first data, and in response thereto,
determining one or more solutions for the provision, each solution comprising information relating to a plurality of components including the first component which can participate to facilitate the provision,
selecting one of said solutions according to a first criterion, and
causing a second data entry relating to the selected solution to be stored in a second data store; and
means for determining that the second data store stores such second data entries, and in response thereto,
selecting one of the entries of second data according to a second criterion, and
causing a blockchain data store to be modified according to the selected entry of second data.

34. A system for resource allocation in a utility service network which network comprises, as components, one or more sources, a number of infrastructure elements and one or more consumer elements, the system comprising:
a first module arranged to, responsive to an indication that a first component wishes to participate in provision of a utility product from a source to a consumer element, cause first data relating to the indication and associated with the first component to be stored in a first data store;
one or more solution engines each arranged to determine that the first data store stores such first data, and in response thereto
determine one or more solutions for the provision, each solution comprising information relating to a plurality of components including the first component which can participate to facilitate the provision,
select one of said solutions according to a first criterion, and
cause a second data entry relating to the selected solution to be stored in a second data store; and
an umpire module arranged to determine that the second data store comprises one or more entries of such second data, and in response thereto
select one of the entries of second data according to a second criterion, and
cause a blockchain data store to be modified according to the selected entry of second data.

35. A module for resource allocation in a utility service network which network comprises, as components, one or more sources, a number of infrastructure elements and one or more consumer elements, the module arranged to:
detect an indication that a first component wishes to participate in provision of a utility product from a source to a consumer element, and in response thereto, cause first data relating to the indication and associated with the first component to be stored in a first data store, wherein the first data comprises one or more conditions required by the first component for its participation in the provision;
detect second data relating to a solution for the provision, the solution comprising information relating to a plurality of components including the first component which can participate to facilitate the provision, and in response thereto, verify that the one or more conditions are met by the solution; and
responsive to a positive verification, provide an indication that resources of the component are permitted to be allocated according to the second data.

36. A solution engine for resource allocation in a utility service network which network comprises, as components, one or more sources, a number of infrastructure elements and one or more consumer elements, the solution engine arranged to:
determine that a first data store stores first data associated with a first component and relating to an indication that the first component wishes to participate in provision of a utility product from a source to a consumer element, and in response thereto:
determine one or more solutions for the provision, each solution comprising information relating to a plurality of components including the first component which can participate to facilitate the provision,
select one of said solutions according to a first criterion, and
cause a second data entry relating to the selected solution to be stored in a second data store.

37. An umpire module for resource allocation in a utility service network which network comprises, as components, one or more sources, a number of infrastructure elements and one or more consumer elements, the module arranged to:
determine that a second data store stores second data entries, each entry relating to a respective solution comprising information relating to a plurality of components which can participate to facilitate provision of a utility product from a source to a consumer element, and in response thereto,
select one of the entries of second data according to a second criterion, and
cause a blockchain data store to be modified according to the selected entry of second data.

38. A computer program comprising instructions which, when executed by one or more processors, cause the one or more processors to perform a method according to any one of claims 1 to 31.

39. A computer-readable medium storing instructions which, when executed by one or more processors, cause the one or more processors to carry out a method according to any one of claims 1 to 31.

40. A method or apparatus substantially as described with reference to any of the accompanying drawings.
